(19) United States
(12) Patent Application Publication
(10) Pub. No.: US 2026/0147143 A1
(43) Pub. Date: May 28, 2026

(54) ARTICLES WITH ANTI-GLARE SURFACES EXHIBITING LOW SPARKLE WITH MINIMAL COLOR ARTIFACTS

(71) Applicant: CORNING INCORPORATED, CORNING, NY (US)

(72) Inventors: Shandon Dee Hart, Elmira, NY (US); Corinne Elizabeth Isaac, Horseheads, NY (US); Shenping Li, Painted Post, NY (US); Wageesha Senaratne, Horseheads, NY (US); William Allen Wood, Painted Post, NY (US); Jun Yang, Los Gatos, CA (US)

(21) Appl. No.: 19/122,042

(22) PCT Filed: Oct. 24, 2023
(86) PCT No.: PCT/US2023/035747

§ 371 Date: Apr. 17, 2025

Related U.S. Application Data
(60) Provisional application No. 63/420,222, filed on Oct. 28, 2022.

(51) Int. Cl. G02B 5/02

(52) U.S. Cl. CPC G02B 5/02

(57) ABSTRACT

Disclosed herein are articles with scattering regions configured to provide relatively low sparkle with minimal color artifacts. The scattering regions can be a portion of a surface of the article comprising a plurality of first regions disposed at a first height and a plurality of second regions disposed at a second height. The scattering regions are designed in the Fourier domain and constructed such that the article exhibits a radial power spectral density comprising a first range of scattering angles in which the radial PSD increases with an increase in a scattering angle of light relative to a specular direction, a peak angle θₚₑₐₖ where the radial PSD comprises a peak value, and a second range of scattering angles at angles greater than θₚₑₐₖ in which the radial PSD rapidly decreases with increasing scattering angle.

### CROSS-REFERENCE TO RELATED APPLICATIONS

This application claims the benefit of priority under 35 U.S.C. § 119 of U.S. Provisional Application Ser. No. 63/420,222 filed on Oct. 28, 2022, the content of which is relied upon and incorporated herein by reference in its entirety.

### FIELD

The disclosure relates to articles with anti-glare surfaces exhibiting low sparkle with minimal color artifacts.

### BACKGROUND

Substrates transparent to visible light are utilized to cover displays of display articles. Such display articles include smart phones, tablets, televisions, computer monitors, vehicle interior displays and the like. The displays are often liquid crystal displays and organic light emitting diodes, among others. The substrate protects the display, while the transparency of the substrate allows the user of the device to view the display. Glare is the phenomena associated with a degraded viewing experience in the presence of bright light sources. In addition, reflected images not from a bright light source but from the ambient can also contribute to a degraded viewing in displays. For example, a visually distinctive user's own reflected image, or light from the surrounding environment, can result in distraction, reduction in legibility, as well as visual fatigue.

Several techniques exist to reduce glare, including anti-reflective coatings and anti-glare technologies. An anti-reflection coating can reduce glare by directly reducing the total amount of reflection. However, certain existing anti-reflection coatings may fail to diminish reflections to a great enough extent throughout the visible spectrum to render such reflections unnoticed by users. Anti-glare technologies attempt to spread reflection of light to a large range of angles to reduce the peak intensity of the reflection and render distracting reflected images less distinct to the user. However, reflection at angles that are too large can result in relatively high haze that can reduce the contrast of the displayed images.

Accordingly, an alternative to existing anti-glare and anti-reflective coating technologies that allows favorable control of the angular distribution of scattered light would be beneficial.

### SUMMARY

An aspect (1) of the present disclosure pertains to an article comprising: a substrate comprising: a first major surface; a second major surface opposing the first major surface; and a scattering region formed in the first major surface, wherein, within the scattering region, the first major surface comprises: a plurality of first regions disposed at a first height relative to an imaginary base plane extending through the substrate, and a plurality of second regions disposed at a second height relative to the imaginary base plane, wherein: the first height is greater than the second height by an etch depth that is greater than or equal to 80 nm and less than or equal to 600 nm, the scattering region comprises a radial PSD that comprises: a first range of scattering angles in which the radial PSD increases with an increase in a scattering angle of light relative to a specular direction, a peak angle θₚₑₐₖ where the radial PSD comprises a peak value, and a second range of scattering angles at angles greater than θₚₑₐₖ in which the radial PSD decreases to 10% of the peak value at a first scattering angle that is greater than or equal to 2° and less than or equal to 150 relative to the specular direction.

An aspect (2) of the present disclosure pertains to an article according to the aspect (1), wherein, within the second range of scattering angles, the radial PSD decreases to 1% of the peak value at a second scattering angle that is greater than the first scattering angle and greater than or equal to 3.5° and less than or equal to 300 relative to the specular direction.

An aspect (3) of the present disclosure pertains to an article according to the aspect (2), wherein, within the first range of scattering angles, the radial PSD is less than 10% of the peak value at scattering angles greater than or equal to 0.05°.

An aspect (4) of the present disclosure pertains to an article according to any of the aspects (2)-(3), wherein: the first scattering angle is greater than or equal to 6° and less than or equal to 130 relative to the specular direction, and the second scattering angle is greater than or equal to 12.5° and less than or equal to 30.0° relative to the specular direction.

An aspect (5) of the present disclosure pertains to an article according to any of the aspects (2)-(3), wherein: the first scattering angle is greater than or equal to 2° and less than or equal to 7° relative to the specular direction, and the second scattering angle is greater than or equal to 3.5° and less than or equal to 13.5° relative to the specular direction.

An aspect (6) of the present disclosure pertains to an article according to the aspect (5), wherein, within the second range of scattering angles, the radial PSD decreases to a value that is 0.1% of the peak value at a third scattering angle that is less than or equal to 8° relative to the specular direction.

An aspect (7) of the present disclosure pertains to an article according to the aspect (5), wherein, within the second range of scattering angles, the radial PSD decreases to a value that is 0.01% of the peak value at a third scattering angle that is less than or equal to 160 relative to the specular direction.

An aspect (8) of the present disclosure pertains to an article according to any of the aspects (1)-(7), wherein θₚₑₐₖ is greater than or equal to 0.3 and less than or equal to 0.5°.

An aspect (9) of the present disclosure pertains to an article according to any of the aspects (1)-(8), wherein: within the scattering region, the first major surface comprises a plurality of sloped transition surfaces extending between boundaries of the plurality of first regions and the plurality of second regions, and the plurality of sloped transition surfaces are sloped such that a height of the first major surface decreases with increasing distance from boundaries of the plurality of first regions.

An aspect (10) of the present disclosure pertains to an article according to the aspect (9), wherein at least some of the plurality of sloped transition surfaces extend a lateral distance that is greater than or equal to 1.0 μm and less than or equal to 10 μm between ones of the plurality of first regions and the plurality of second regions that are connected by the sloped transition surfaces, wherein the lateral distance extended by a sloped transition surface is measured in a direction parallel to a surface normal of the sloped transition surface and parallel to the imaginary base plane.

An aspect (11) of the present disclosure pertains to an article according to any of the aspects (1)-(10), wherein the article exhibits: a transmission haze of less than or equal to 2.0%, and a sparkle of less than or equal to 2.5% when measured at 140 ppi.

An aspect (12) of the present disclosure pertains to an article according to any of the aspects (1)-(11), wherein a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.55 when the article is viewed at a 0° viewing angle and light having a luminance of 45000 lux is incident on the first major surface at an angle of incidence of 20°.

An aspect (13) of the present disclosure pertains to an article according to any of the aspects (1)-(12), wherein the first average modulation transfer function is at least 0.7 when the article is viewed at the 0° viewing angle and light having a luminance of 45000 lux is incident on the first major surface at the angle of incidence of 20°.

An aspect (13) of the present disclosure pertains to an article according to any of the aspects (1)-(13), wherein a second average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.6 when the article is viewed at a 20° viewing angle and light having a luminance of 45000 lux is incident on the first major surface at an angle of incidence of 45°.

An aspect (14) of the present disclosure pertains to an article according to the aspect (1), wherein: within the scattering region, the first major surface comprises: a plurality of third regions disposed at a third height relative to the imaginary base plane, and a plurality of fourth regions disposed at a fourth height relative to the imaginary base plane, and the fourth height is different from the first height, the second height, and the third height.

An aspect (15) of the present disclosure pertains to an article according to the aspect (15), wherein the article exhibits: a specular reflectance (Rs) of less than or equal to 4.0, and a coupled distinctness of image of less than 65%.

An aspect (17) of the present disclosure pertains to an article according to any of the aspects (1)-(16), wherein the substrate is a glass substrate, wherein the article further comprises a display disposed adjacent to the second major surface and configured to emit light through the substrate.

An aspect (18) of the present disclosure pertains to an article comprising: a first major surface; a second major surface opposing the first major surface; and a scattering region formed in the first major surface, wherein, within the scattering region, the first major surface comprises: a plurality of first regions disposed at a first height relative to an imaginary base plane extending through the substrate, and a plurality of second regions disposed at a second height relative to the imaginary base plane, wherein: the first height is greater than the second height by an etch depth that is greater than or equal to 80 nm and less than or equal to 600 nm, the scattering region comprises a radial PSD that comprises a first range of scattering angles on one side of a peak angle (θₚₑₐₖ) where the radial PSD increases with increasing scattering angle and a second range of scattering angles on a second side of θₚₑₐₖ where the radial PSD decreases with increasing scattering angle, a bidirectional reflectance distribution function (“BRDF”) of the article is less than 10⁻⁵ times a peak intensity value at a scattering angle of 20° relative to specular, and the BRDF is measured from light having a wavelength of 520 nm that is incident on the first major surface at an angle of incidence of 20°.

An aspect (19) of the present disclosure pertains to an article according to the aspect (18), wherein the BRDF comprises an amplitude of less than 1.7×10⁻⁴ sr⁻¹ at a 30° scattering angle relative to specular.

An aspect (20) of the present disclosure pertains to an article according to any of the aspects (18)-(19), wherein, within the second range of scattering angles, the radial PSD decreases to 10% of a peak value at θₚₑₐₖ at a first scattering angle that is greater than or equal to 2° and less than or equal to 15° relative to the specular direction.

An aspect (21) of the present disclosure pertains to an article according to the aspect (20), wherein, within the second range of scattering angles, the radial PSD decreases to a value that is 1% of the peak value at a second scattering angle that is greater than the first scattering angle and greater than or equal to 3.5° and less than or equal to 30° relative to the specular direction.

An aspect (22) of the present disclosure pertains to an article according to the aspect (21), wherein, within the second range of scattering angles, the radial PSD decreases to a value that is 0.1% of the peak value at a third scattering angle that is less than or equal to 8° relative to the specular direction.

An aspect (23) of the present disclosure pertains to an article according to the aspect (22), wherein, within the second range of scattering angles, the radial PSD decreases to a value that is 0.01% of the peak value at a third scattering angle that is less than or equal to 160 relative to the specular direction.

An aspect (24) of the present disclosure pertains to an article according to any of the aspects (20)-(23), wherein, within the first range of scattering angles, the radial PSD is less than 10% of the peak value at scattering angles greater than or equal to 0.05.°

An aspect (25) of the present disclosure pertains to an article according to any of the aspects (18)-(24), wherein θₚₑₐₖ is greater than or equal to 0.3 and less than or equal to 0.5°.

An aspect (26) of the present disclosure pertains to an article according to any of the aspects (18)-(26), wherein: within the scattering region, the first major surface comprises a plurality of sloped transition surfaces extending between boundaries of the plurality of first regions and the plurality of second regions, and the plurality of sloped transition surfaces are sloped such that a height of the first major surface decreases with increasing distance from boundaries of the plurality of first regions.

An aspect (27) of the present disclosure pertains to an article according to the aspect (26), wherein at least some of the plurality of sloped transition surfaces extend a lateral distance that is greater than or equal to 1.0 μm and less than or equal to 10 μm between ones of the plurality of first regions and the plurality of second regions that are connected by the sloped transition surfaces, wherein the lateral distance extended by a sloped transition surface is measured in a direction parallel to a surface normal of the sloped transition surface and parallel to the imaginary base plane.

An aspect (28) of the present disclosure pertains to an article according to any of the aspects (18)-(27), wherein the article exhibits: a transmission haze of less than or equal to 2.0%, and a sparkle of less than or equal to 2.5% when measured at 140 ppi.

An aspect (29) of the present disclosure pertains to an article comprising a substrate comprising: a first major surface; a second major surface opposing the first major surface; and a scattering region formed in the first major surface, wherein, within the scattering region, the first major surface comprises: a plurality of first regions disposed at a first height relative to an imaginary base plane extending through the substrate, a plurality of second regions disposed at a second height relative to the imaginary base plane, and a plurality of sloped transition surfaces extending between boundaries of the plurality of first regions and the plurality of second regions, wherein: the plurality of sloped transition surfaces are sloped such that a height of the first major surface decreases with increasing distance from boundaries of the plurality of first regions, at least some of the plurality of sloped transition surfaces extend a lateral distance that is greater than or equal to 1.0 μm and less than or equal to 10 μm between ones of the plurality of first regions and the plurality of second regions that are connected by the sloped transition surfaces, wherein the lateral distance extended by a sloped transition surface is measured in a direction parallel to a surface normal of the sloped transition surface and parallel to the imaginary base plane, and the scattering region comprises a radial PSD that comprises: a first range of scattering angles where the radial PSD increases with an increase in a scattering angle of light relative to a specular direction, a peak scattering angle θₚₑₐₖ where the radial PSD comprises a peak value, and a second range of scattering angles at scattering angles greater than θₚₑₐₖ where the radial PSD decreases to 10% of the peak value at a first scattering angle that is greater than or equal to 2° and less than or equal to 15° relative to the specular direction.

An aspect (30) of the present disclosure pertains to an article according to the aspect (29), wherein, within the first range of scattering angles, the radial PSD is less than 10% of the peak value at scattering angles greater than or equal to 0.05.°

An aspect (31) of the present disclosure pertains to an article according to any of the aspects (29)-(30), wherein θₚₑₐₖ is greater than or equal to 0.3 and less than or equal to 0.5°.

An aspect (32) of the present disclosure pertains to an article according to any of the aspects (29)-(31), wherein: the first scattering angle is greater than or equal to 6° and less than or equal to 130 relative to the specular direction, and within the second range of scattering angles, the radial PSD decreases to 1% of the peak value at a second scattering angle that is greater than or equal to 12.5° and less than or equal to 30.0° relative to the specular direction.

An aspect (33) of the present disclosure pertains to an article according to any of the aspects (29)-(31), wherein: the first scattering angle is greater than or equal to 2° and less than or equal to 7° relative to the specular direction, and within the second range of scattering angles, the radial PSD decreases to 1% of the peak value at a second scattering angle that is greater than or equal to 3.5° and less than or equal to 13.5° relative to the specular direction.

An aspect (34) of the present disclosure pertains to an article according to the aspect (33), wherein, within the second range of scattering angles, the radial PSD decreases to a value that is 0.1% of the peak value at a third scattering angle that is less than or equal to 8° relative to the specular direction.

An aspect (35) of the present disclosure pertains to an article according to the aspect (34), wherein, within the second range of scattering angles, the radial PSD decreases to a value that is 0.01% of the peak value at a third scattering angle that is less than or equal to 160 relative to the specular direction.

An aspect (36) of the present disclosure pertains to an article according to any of the aspects (29)-(35), wherein the article exhibits: a transmission haze of less than or equal to 2.0%, and a sparkle of less than or equal to 2.5% when measured at 140 ppi.

An aspect (37) of the present disclosure pertains to an article according to any of the aspects (29)-(36), wherein: a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.07 when the article is viewed at a 0° viewing angle and light having a luminance of 45000 lux is incident on the first major surface at an angle of incidence of 20°, and a second average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.6 when the article is viewed at a 20° viewing angle and light having a luminance of 45000 lux is incident on the first major surface at an angle of incidence of 45°.

An aspect (38) of the present disclosure pertains to an article according to the aspect (29), wherein: within the scattering region, the first major surface comprises: a plurality of third regions disposed at a third height relative to the imaginary base plane, and a plurality of fourth regions disposed at a fourth height relative to the imaginary base plane, and the fourth height is different from the first height, the second height, and the third height.

An aspect (39) of the present disclosure pertains to an article according to the aspect (38), wherein the article exhibits: a specular reflectance (Rs) of less than or equal to 4.0, and a coupled distinctness of image of less than 65%.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, explain the principles of the invention. In the drawings:

FIG. 1 depicts a perspective view of a display article, according to one or more embodiments of the present disclosure;

FIG. 2 schematically depicts a portion of a scattering region of the display article of FIG. 1, according to one or more embodiments of the present disclosure;

FIG. 3A schematically depicts a height profile of the scattering region depicted in FIG. 2, according to one or more embodiments of the present disclosure;

FIG. 3B schematically depicts a cross-sectional view of a transition surface between two regions at different heights of the scattering region depicted in FIG. 2, according to one or more embodiments of the present disclosure;

FIG. 4 is a plot of a plurality target radial power spectral densities for a scattering region, according to one or more embodiments of the present disclosure;

FIG. 5 is a flow diagram of a method of formulating a phase map for a scattering region based on a target radial power spectral density (“PSD”) for that scattering region, according to one or more embodiments of the present disclosure;

FIG. 6A is a plot of modelled sparkle and transmission haze performance for example articles as a function of an α parameter for a target radial PSD used to construct those samples, according to one or more embodiments of the present disclosure;

FIG. 6B depicts a qualitative simulated color appearance of reflected light from the samples represented in FIG. 6A for various levels of detector saturation, for values of the a ranging from 0.1 to 1.0 according to one or more embodiments of the present disclosure;

FIG. 6C depicts a qualitative simulated color appearance of reflected light from the samples represented in FIG. 6A for various levels of detector saturation, for values of the a ranging from 1.0 to 10.0 according to one or more embodiments of the present disclosure;

FIG. 6D is a plot of a target radial PSD both before and after being modified by phase thresholding to provide a binary phase mask, according to one or more embodiments of the present disclosure;

FIG. 6E depicts a block of a phase map after phase thresholding, according to one or more embodiments of the present disclosure;

FIG. 6F is a plot of a radial PSD both prior to modification and after modification to achieve a localized fill fractions of 50% for each phase after phase thresholding, according to one or more embodiments of the present disclosure;

FIG. 7 is a flow diagram of a method of fabricating an article with a scattering region by performing one or more etching steps on a surface of the article, according to one or more embodiments of the present disclosure;

FIG. 8 schematically depicts an apparatus for measuring washout performance of an article, according to one or more embodiments of the present disclosure;

FIG. 9 schematically depicts a vehicle interior comprising displays and ambient light sources emitting light that is incident on and scattered from the displays, according to one or more embodiments of the present disclosure;

FIGS. 10A-10F are images of a plurality of patterns emitted through a sample having an existing anti-glare surface treatment when illuminated under conditions via the apparatus depicted in FIG. 8, according to one or more embodiments of the present disclosure;

FIGS. 11-12 are plots of modulation transfer function measurements from the images shown FIGS. 10A-10F, according to one or more embodiments of the present disclosure;

FIGS. 13A-13D are images of a plurality of patterns emitted through samples having scattering regions formed from target radial PSDs described herein when illuminated under conditions via the apparatus depicted in FIG. 8, according to one or more embodiments of the present disclosure;

FIG. 14 is a plot of specular reflectance (Rs) measurements as a function of sparkle measurements for a first set of examples fabricated via the methods depicted in FIGS. 5 and 7, according to one or more embodiments of the present disclosure;

FIG. 15A schematically depicts a portion of a modelled surface having a first region disposed at a first height, a second region disposed at a second height, and a transition surface extending between the first region and the second region, according to one or more embodiments of the present disclosure;

FIG. 15B depicts a cross-sectional view of the modelled surface depicted in FIG. 15A through the line 1504 depicted in FIG. 15A, according to one or more embodiments of the present disclosure;

FIG. 15C depicts a plot of surface height measurements along the line 1504 across the transition surface of the modelled surface depicted in FIG. 15A, according to one or more embodiments of the present disclosure;

FIG. 15D depicts a plot of a modeled specular reflection reduction spectrum of the modelled surface depicted in FIG. 14A, according to one or more embodiments of the present disclosure;

FIG. 16A schematically depicts a portion of a modelled surface that is a modified version of the modelled surface depicted in FIG. 15A to include feature rounding such that the slope of the modified surface transitions more gradually between the first region and the transition surface, according to one or more embodiments of the present disclosure;

FIG. 16B depicts a cross-sectional view of the modelled surface depicted in FIG. 16A through the line 1504 depicted in FIG. 16A, according to one or more embodiments of the present disclosure;

FIG. 16C depicts a plot of surface height measurements along the line 1504 across the transition surface of the modelled surface depicted in FIG. 16A, according to one or more embodiments of the present disclosure;

FIG. 16D depicts a plot of a modeled specular reflection reduction spectrum of the modelled surface depicted in FIG. 16A, according to one or more embodiments of the present disclosure;

FIG. 17 is a plot of modelled radial PSDs for a plurality of modelled surface with different degrees of feature rounding, according to one or more embodiments of the present disclosure;

FIGS. 18A and 18B depict images of planar and perspective views of a first article fabricated via the methods depicted in FIGS. 5 and 7 without feature rounding, according to one or more embodiments of the present disclosure;

FIGS. 18C and 18D depict images of planar and perspective views of a second article fabricated via the methods depicted in FIGS. 5 and 7 with feature rounding, according to one or more embodiments of the present disclosure;

FIG. 18E is a plot of radial PSDs measured from surfaces of the first and second articles depicted in FIGS. 18A-18D, according to one or more embodiments of the present disclosure; and

FIG. 19 is a plot of bidirectional reflection distribution functions measured from a plurality of samples both including and not including feature rounding and fabricated via the methods depicted in FIGS. 5 and 7 with different target radial PSDs, according to one or more embodiments of the present disclosure.

### DETAILED DESCRIPTION

Referring generally to the figures, described herein are articles comprising a surface with a scattering region designed to provide favorable combinations of anti-glare (“AG”) performance attributes. The scattering regions are designed in the spatial frequency domain based on a target radial power spectral density (“PSD”) for the article and converting the target radial PSD to a phase profile (or “phase map”) that is used to form a plurality of surface features in the scattering region. The surface features may comprise regions of the surface that are disposed at different heights relative to an imaginary base plane extending through the article and transition surfaces extending between the regions. The surface features are constructed such that the scattering region exhibits a radial PSD that comprises a first range of scattering angles in which the radial PSD increases with increasing scattering angle relative to specular, a peak scattering angle θₚₑₐₖ where the radial PSD comprises a peak value, and a second range of scattering angles where the radial PSD decreases with increasing scattering angle relative to specular. The methods of forming the plurality of surface features described herein facilitate the radial PSD rapidly decreasing with increasing scattering angle within the second range of scattering angles, such that, within the second range of scattering angles, the PSD decreases to 10% of the peak value at a first scattering angle that is less than or equal to 15° relative to specular and to 1% of the peak value at a second scattering angle that is less than or equal to 30° relative to specular. Such rapid decline within the second range of scattering angles facilitates the articles described herein exhibiting favorable combinations of AG performance attributes for various applications while introducing minimal observable color artifacts.

To achieve the radial PSD described herein that rapidly declines within the second range of scattering angles, boundaries of the regions of the surface that are disposed at the different heights may be rounded so that transitions in slope of the first major surface (e.g., between a region disposed at one of the heights and a transition surface) are more gradual as compared to surfaces without feature rounding via the methods described herein. As a result, within the scattering region, adjacent regions of the first major surface disposed at different heights relative to the imaginary base plane may be separated by a lateral distance, measured in a direction parallel to a surface normal of the transition surface and parallel to the imaginary base plane, of greater than or equal to 1.0 μm (e.g., greater than or equal to 1.0 μm and less than or equal to 10 μm, greater than or equal to 1.0 μm and less than or equal to 9.0 μm, greater than or equal to 1.0 μm and less than or equal to 8.0 μm, greater than or equal to 1.0 μm and less than or equal to 7.0 μm, greater than or equal to 1.0 μm and less than or equal to 6.0 μm, greater than or equal to 1.0 μm and less than or equal to 5.0 μm, greater than or equal to 2.0 μm and less than or equal to 5.0 μm). Such gradual surface height transitions are achievable by controlling the surface energy between a resist and the article during the etching process of forming the scattering regions described herein. Lack of sharpness in surface height transitions reduces the radial PSD at high scattering angles and aids in favorable washout and transmission haze performance.

A context where the articles described herein may be particularly useful is in the context of vehicle interior displays. Vehicle interiors may include one or more displays (e.g., center counsel displays, dashboard displays, pillar displays, seatback displays, and others). Such displays may be fixed in orientation relative to the driver. When in operation, vehicles are subject to ambient light conditions that can cause relatively severe glare. For example, sunlight can enter the vehicle interior through a side window or windshield and reflect or scatter off of the displays, causing bright glare that can distract the driver and degrade performance of the display due to washout. The articles described herein may reduce such washout from commonly encountered ambient light conditions due to the rapid falloff of the radial PSD achieved in the second range of scattering angles. Such favorable washout performance may be achieved while also providing favorable sparkle and transmission haze performance.

As used herein, the term “radial PSD,” when used in describing a surface of a particular article, refers to a profile calculated from a surface height profile that is measured from the surface Particularly, the surface height profile of a 1×1 mm area of the surface is measured using white light interferometry. The surface height profile data array is input to the Gwyddion data analysis program to compute the radial power spectral density. The term “radial PSD” is to be differentiated from the term “target radial PSD.” The target radial PSD is not calculated from a measured surface height profile of a surface, but is instead calculated mathematically from the desired far-field scattering pattern of the surface.

As used herein, “specular reflectance (Rs)” or “Rs” is defined as the peak intensity of light reflected from a first surface of a substrate within a cone of angles of +/−0.10. Specular reflectance may be measured using a Rhopoint IQ meter, which reports an Rs value that is in Gloss Units.

Articles described herein may be characterized by a distinctness-of-image value. “Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angles (from 0.2° to 0.4° away from specular). Such measurements can be made using a goniophotometer (Rhopoint IQ (Goniophotometer) 20°/60°/85°, Rhopoint Instruments) that is calibrated to a certified black glass standard, as specified in ASTM procedures D523 and D5767.

As used, herein, the term “haze” or “transmission haze” refers to the percentage of transmitted light scattered outside an angular cone of about ±2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well. For an optically smooth surface, transmission haze is generally close to zero.

As used herein, the terms “sparkle,” “sparkle contrast,” “display sparkle,” “pixel power deviation,” “PPD”, or like terms refers to the visual phenomenon that occurs when a textured transparent surface is combined with a pixelated display. Generally speaking, quantization of sparkle involves imaging a lit display or simulated display with the textured surface in the field of view. The calculation of sparkle for an area P is equal to σ(P)/μ(P), where σ(P) is the standard deviation of the distribution of integrated intensity for each display pixel contained within area P divided by the mean intensity σ(P). Following the guidance in: (1) J. Gollier, et al., “Apparatus and method for determining sparkle,” U.S. Pat. No. 9,411,180B2, United States Patent and Trademark Office, 20 Jul. 2016; (2) A. Stillwell, et al., “Perception of Sparkle in Anti-Glare Display Screens,” JSID 22(2), 129-136 (2014); and (3) C. Cecala, et al., “Fourier Optics Modeling of Display Sparkle from Anti-Glare Cover Glass: Comparison to Experimental Data”, Optical Society of America Imaging and Applied Optics Congress, JW5B.8 (2020); one skilled in the art can build an imaging system to quantify sparkle. Alternatively, a commercially available system (e.g. the SMS-1000, Display Messtechnik & Systeme GmbH & Co. KG, Germany) can also be used. Unless described otherwise, sparkle is measured with a 140 PPI display using the following procedure. A 140 PPI display (e.g. Z50, Lenovo Group Limited, Hong Kong) with only the green subpixels lit (R=0, B=0, G=255), at full display brightness is imaged using a Φ=50 mm lens/machine vision camera combination (e.g. C220503 1:2.8 50 mm Φ30.5, Tamron, Japan) and Stingray F-125 B, Allied Vision Technologies GmbH, Germany). The lens settings are aperture=5.6, depth of field=0.3, working distance=about 290 mm; with these settings, the ratio of display pixels to camera pixels is approximately 1 to 9. The field of view for analysis contains approximately 7500 display pixels. Camera settings have the gain and gamma correction turned off. Periodic intensity variations from, e.g. the display, and non-periodic intensity variations, e.g. dead pixels, are removed during analysis prior to the calculation of sparkle.

Anti-glare performance can be measured with nothing coupled to the surface (herein described as “uncoupled”) or a black absorber coupled to a rear surface of the glass (herein described as “coupled”).

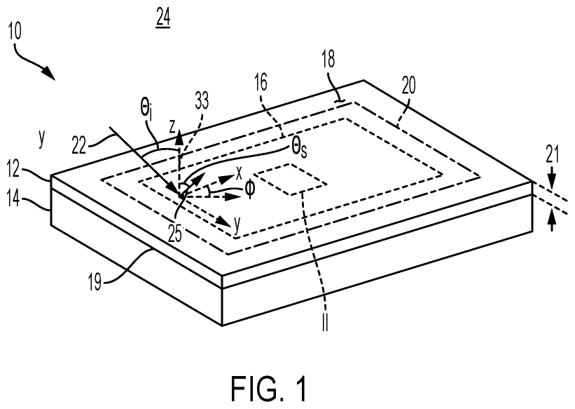

Referring now to FIG. 1, an article 10 is depicted, according to an example embodiment. The article 10 comprises a substrate 12. In the depicted embodiment, the article 10 is a display article (e.g., a display cover article) and further includes a housing 14 to which the substrate 12 is coupled and a display 16 within the housing 14. In such embodiments, the substrate 12 at least partially covers the display 16 such that light that the display 16 emits can transmit through the substrate 12.

The substrate 12 may be a variety of materials depending on the implementation. For example, in embodiments, such as in the embodiment depicted in FIG. 1, the substrate 12 is a glass or glass-ceramic substrate. Various properties and examples for such glass or glass-ceramic substrates are described in greater detail herein. In embodiments, the substrate 12 may be constructed of a material other than glass such as paper, plastic or other suitable polymeric material. In embodiments, the substrate 12 can include a combination of glass and polymeric materials. In an example, the scattering region 20 described herein is formed in a layer of polymeric material formed on a glass substrate. In embodiments, the substrate 12 is transparent, or exhibits an average transmittance for light normally incident on the substrate 12 that is in a wavelength range of 400 nm to 700 nm of greater than or equal to 70% (e.g., greater than or equal to 80%, greater than or equal to 85%, greater than or equal to 90%, greater than or equal to 92%, greater than or equal to 92.5%, greater than or equal to 93%). In embodiments, the substrate 12 is opaque or exhibits an average transmittance for light normally incident on the substrate that is in a wavelength range of 400 nm to 700 nm that is less than or equal to 30%. In embodiments, the substrate 12 is tinted to exhibit a colored appearance under ambient illumination (e.g., from sunlight).

The substrate 12 includes a first major surface 18, a second major surface 19, a scattering region 20 defined on the first major surface 18, and a thickness 21 that the first major surface 18 bounds in part (e.g., representing a minimum distance between the first major surface 18 and the second major surface 19 at a particular point on the first major surface 18).

In the depicted embodiment, the substrate 12 is substantially planar in shape such that the first major surface 18 and the second major surface 19 are generally flat (with the exception of plurality of surface features formed in the first major surface 18, as described herein). Embodiments where the substrate 12 comprises a curved shape (e.g., via suitable hot-forming and cold-forming techniques) are also contemplated and within the scope of the present disclosure. In such embodiments, references to the “surface normal” (depicted as the surface normal 33 in FIG. 1) herein are to a local surface normal at a point where light from an external environment 24 is incident on the first major surface 18. In the depicted embodiment, the first major surface 18 generally faces toward the external environment 24 surrounding the article 10 and away from the display 16. In embodiments, the display 16 emits visible light that transmits through the thickness 21 of the substrate 12, out the first major surface 18, and into the external environment 24.

As depicted in FIG. 1, light from the external environment 24, represented by incoming light ray 22, may be incident on the first major surface 18 at an angle of incidence θᵢ (representing a zenith angle that the incoming light ray 22 extends relative to the surface normal 33 of the first major surface 18, depicted as the z-direction in FIG. 1). The incoming light ray 22 may represent light from a number of different sources from outside of the article 10. For example, the incoming light ray 22 may represent sunlight that is incident on the first major surface 18 or light from another external light source (e.g., light reflected or scattered from an external object, light generated by another source). The scattering region 20 scatters the light represented by the incoming light ray 22 in a scattering direction, represented by the scattered light ray 25. Light is scattered in a particular direction with a scattering amplitude that depends on the angle of incidence θᵢ and a scattering angle θₛ relative to the surface normal 33. As shown, the scattered light ray 25 is scattered in a scattering direction that, when projected into a plane of the first major surface 18 extending perpendicular to the surface normal 33, extends at an azimuthal angle Φ relative to a first direction (the x-direction depicted in FIG. 1).

As described herein, the scattering region 20 is designed based on a target radial PSD. The target radial PSD is azimuthally averaged with respect to the azimuthal angle (such that the PSD is statistically isotropic with respect to the azimuthal angle. Irrespective of the azimuthal angle Φ, the target radial PSD varies with the zenith angle θₛ in accordance with the same functional relationship. Such a target radial PSD beneficially minimizes the effects of rotational orientation of the article 10 in the external environment 24 on AG performance.

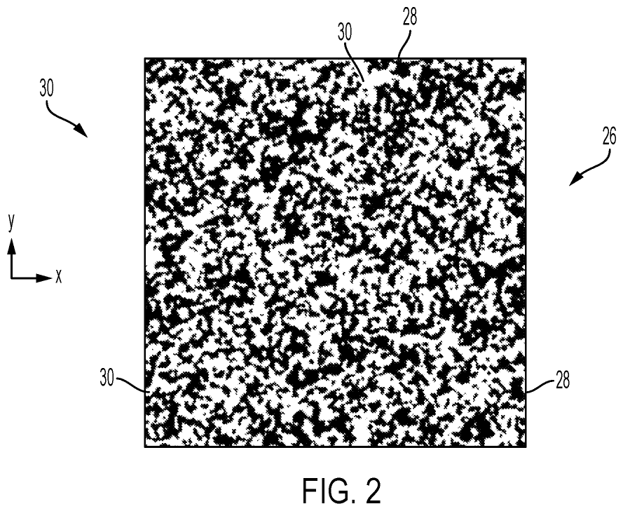

FIG. 2 schematically depicts a plan view of the region II of the scattering region 20 of the article 10 depicted in FIG. 1, according to an example embodiment of the present disclosure. As shown, the scattering region 20 comprises a plurality of surface features 26. The plurality of surface features 26 are designed based on a target radial PSD in the Fourier domain, as described herein. In the depicted example, the plurality of surface features 26 comprises a plurality of first regions 28 of the first major surface 18 and a plurality of second regions 30 of the first major surface 18. The plurality of first regions 28 and the plurality of second regions 30 are regions of the first major surface 18 that are generally disposed at different heights. In embodiments, the plurality of first regions 28 and the plurality of second regions 30 can be characterized as being planar in the sense that, within each of the regions, the surface height of the first major surface 18 does not substantially vary. For example, in embodiments, within a particular one of the plurality of first regions 28 or one of the plurality of second regions 30, the surface height variation (or roughness) may be less than 50 nm, in terms of root-mean-square (RMS) variation (or less than 20 nm RMS, or less than 10 nm RMS). For example, in these embodiments, each of the plurality of first regions 28 and the plurality of second regions 30 can be characterized by a surface height variation from 0.1 nm RMS to 50 nm RMS, from 0.1 nm RMS to 20 nm RMS, from 0.1 nm RMS to 10 nm RMS, or from 0.1 nm RMS to 1 nm RMS.

In embodiments, at least some of the plurality of first regions 28 and the plurality of second regions 30 may not be planar in shape, but rather comprise rounded surfaces extending at non-constant heights. In such embodiments, the plurality of first regions 28 and the plurality of second regions 30 may be approximated as planar surfaces and an average height. Each of the plurality of first regions 28, for example, may be considered an area of the first major surface 18 disposed at a first average height and each of the plurality of second regions 30 may be considered an area of the first major surface 18 disposed at a second average height, where the first average height differs from the second average height by at least 100 nm.

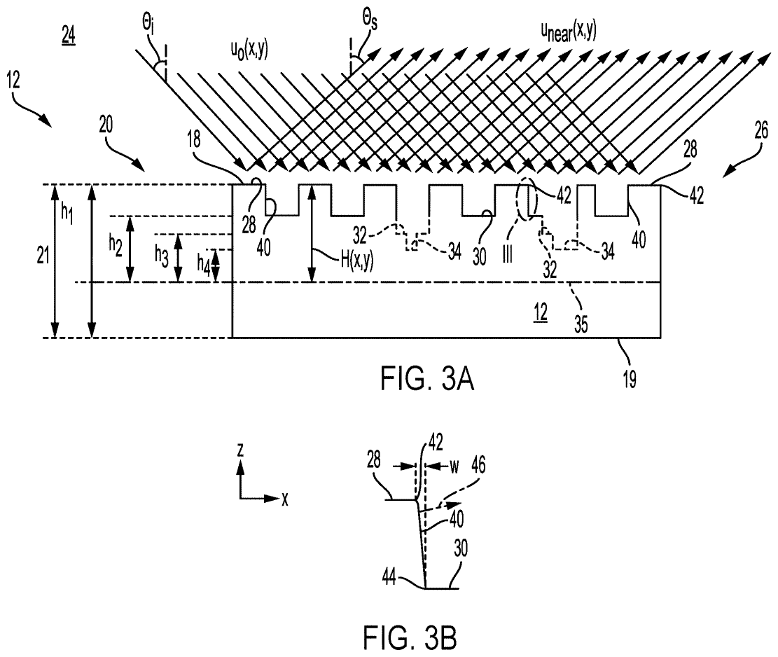

The plurality of surface features 26 generally vary in size and peripheral shape, and comprise lengthwise axes that extend in a plurality of different directions in a plane parallel to the imaginary base plane 35 (see FIG. 3A). However, randomness in the structure of the plurality of surface features 26 differs from that in certain existing AG surfaces (e.g., produced by sandblasting) in that the arrangement of the plurality of surface features 26 is reproducible (within a manufacturing tolerance) via the methods described herein.

Referring to FIGS. 2-3A, in the depicted example, the plurality of first regions 28 are disposed at a first height h₁ relative to an imaginary base plane 35 extending through the substrate 12 and the plurality of second regions 30 are disposed at a second height h₂ relative to the imaginary base plane 35. In the depicted example, the plurality of surface features 26 are regions of constant height of the first major surface 18 (with the understanding that the actual structure of the plurality of surface features 26 may include surface height deviations associated with the roughness of the first major surface 18 and may also not exactly extend in the x-y plane due to effects of the process of forming the plurality of surface features 26, such as the etching process described herein). The plurality of surface features 26 may also include closed microstructures (where a boundary associated with a particular surface feature is a closed contour). Additionally certain ones of the plurality of first regions 28 are completely surrounded ones of the plurality of second regions 30 and vice versa.

As shown in FIG. 3A, the plurality of first regions 28 and the plurality of second regions 28 are separated from one another by transition surfaces 40 of the first major surface. The transition surfaces 40 represent segments the first major surface 18 where a height of the first major surface 18 varies to a greater extent than in the plurality of first regions 28 and the plurality of second regions 30. An average slope of the first major surface 18 within the transition surfaces 40 may be greater than the average slope within the plurality of first regions 28 and the plurality of second regions 30. In embodiments, the transition surfaces 40 comprise regions of the first major surface 18 where the surface height varies by greater than or equal to 50 nm per 1 μm of linear distance (e.g., greater than or equal to 100 nm per 1 μm of linear distance, greater than or equal to 200 nm per 1 μm of linear distance, greater than or equal to 300 nm per 1 μm of linear distance, greater than or equal to 400 nm per 1 μm of linear distance, greater than or equal to 500 nm per 1 μm of linear distance, greater than or equal to 500 nm per 1 μm of linear distance) measured in a direction extending perpendicular to the transition surface 40, where the linear distance is measured in a plane parallel to the imaginary base plane 35.

With reference to FIG. 3B, in embodiments, each of the transition surfaces 40 comprises a first edge 42 disposed proximate to one of the plurality of first regions 28 and a second edge 44 disposed proximate to one of the plurality of second regions 30. The first edge 42 may represent an outer boundary of one of the plurality of first regions 28 and the second edge 44 may represent an outer boundary of an adjacent one of the plurality of second regions 30. As shown in FIG. 3B, the transition surface 40 may comprise a width w. The width w is measured as a lateral distance in a plane parallel to the imaginary base plane 35 (the x-y plane depicted in FIGS. 1-2) between the first edge 42 and the second edge 44. The lateral distance is also measured in a direction extending parallel to a projection of a surface normal 46 of the transition surface 40 into the x-y plane. In embodiments, the width w is greater than or equal to 1.0 μm and less than or equal to 10.0 μm (e.g., greater than or equal to 1.0 μm and less than or equal to 9.0 μm, greater than or equal to 1.0 μm and less than or equal to 8.0 μm, greater than or equal to 1.0 μm and less than or equal to 7.0 μm, greater than or equal to 1.0 μm and less than or equal to 6.0 μm, greater than or equal to 1.5 μm and less than or equal to 6.0 μm, greater than or equal to 2.0 and less than or equal to 6.0 μm). Widths within such ranges indicate a lack of sharpness in transitions of the slope of the first major surface 18. Rather than relatively sharp corners at the first and second edges 42 and 44, the first major surface 18 transitions between slopes gradually (e.g., as in a rounded corner). As described in greater detail herein, such feature rounding aids in reducing high spatial frequency content in the radial PSD of the scattering region 20, thereby providing favorable washout performance. Unless otherwise specified, the width w is a maximum measured value for the lateral distance over a particular transition surface.

The width w can be measured in a variety of different techniques. For example, the width w may be physically measured by generating line profiles of the first major surface 18. The line profiles may be generated by surface height measurements of the first major surface 18 via white light interferometry. Line profiles may also be obtained by cutting a cross-section of the substrate 12 in a direction extending perpendicular to the transition surface 40 and obtaining an image of the cross section (e.g., using a scanning electron microscope of an atomic force microscope). The images are sampled in directions extending perpendicular to the transition surface 40 at a point where the width w is being measured (in a direction extending parallel to a projection of the surface normal 46 into the x-y plane, with that surface normal being located at the first edge 42). The width w at a particular point on a transition surface 40 is calculated as a minimum lateral distance between points disposed at heights that differ from one another by within 10% of a difference between h₁ and h₂ (where the difference between h₁ and h₂ represents an etch depth used in fabricating the article 10). The particular modality used to image the first major surface 18 in measuring the width w may vary depending on the size of the width w. When the width is less than 2.0 μm, atomic force microscopy may be used to image the first major surface 18. When the width w is greater than or equal to 2.0 μm, line profiles may be extracted from white light interferometer data collected at less than 0.2 nm lateral resolution. The resulting width w may be measured as the minimum lateral distance between points disposed at heights that differ from one another by within 10% of a difference between h₁ and h₂.

Referring again to FIG. 3A, the physical structure of the plurality of surface features 26 may be determined using a Fourier analysis of diffraction. As shown in FIG. 3A, incoming radiation from the external environment 24 may be approximated as uniform planewave expressed as

$${u}_{0} ( x , y ) = \sqrt{{I}_{0}} {e}^{i ( {k}_{x o} x + {k}_{y o} y )} \qquad ( 1 )$$

where Iₒ represents a uniform intensity of incoming radiation and kₓₒ and k_{yo} represent wave vector components associated with the wavelength and angle of incidence of incoming radiation on the first major surface 18 (e.g., the angle of incidence may be broken up into components in x-z and y-z planes depicted in FIG. 1). In such a case, the scalar near field for the outgoing radiation (after interaction with the first major surface 18) can be approximated as

$${u}_{near} ( x , y ) = ρ {u}_{0} ( x , y ) \cdot {e}^{i ϕ ( x , y )} \qquad ( 2 )$$

where ρ is the Fresnel coefficient of the interface, and

$$ϕ ( x , y ) = \frac{2 π}{λ} 2 H ( x , y )$$

is the local phase accumulated through the double passage of the distance to the first major surface 18 and H(x,y) represents the pattern formed by the plurality of surface features 26. In this example, incoming radiation is approximated as having a uniform intensity distribution and the interface between the substrate 12 and the external environment 24 is approximated as only applying a spatially varying phase such that the outgoing radiation in the near field also has a uniform intensity distribution.

In this example depicted in FIG. 3, the far field scattering pattern associated with the outgoing radiation may be represented in spatial frequency (k) space and is related to the near field uₙₑₐᵣ(x, y) computed using Equation 3 through a Fourier transform and expressed as

$${u}_{far} ( {k}_{x} , {k}_{y} ) = ℱ [ {u}_{near} ( x , y ) ] = \int \int {dxdye}^{- i ( {k}_{x} x + {k}_{y} y )} {u}_{near} ( x , y ) , \qquad ( 3 )$$

where kₓ and k_{y} represent scattering vector components (kₓ=|k|*cos(Φ), k_{y}=|k|*sin(Φ)), where k is expressed as

$$k = 2 π \frac{sin {θ}_{s}}{λ} , \qquad ( 4 )$$

Φ is the azimuthal angle depicted in FIG. 3, and λ is the wavelength of the scattered radiation.

As used herein, the “PSD” of the scattering region 20 is expressed as

$$PSD ( k ; λ ) = \frac{1}{A} {\vert {u}_{far} \vert}^{2} \qquad ( 5 )$$

where A is the area of the scattering region 20. As used herein, the term “target radial PSD” refers to Equation 5 when averaged over the full range of azimuthal angles Φ. The target radial PSD is expressed as an azimuthally averaged PSD ( [symbol] PSD [symbol] _{Φ}) using the following equation:

$${〈 PSD 〉}_{Φ} ( \vert k \vert ; λ ) = \frac{1}{2 π} {\int }_{0}^{2 π} PSD ( k ; λ ) d Φ . \qquad ( 6 )$$

As such, target radial PSDs only depend on the magnitude of the spatial frequency and the wavelength of the scattered radiation. Unless expressed otherwise, radial PSDs are expressed assuming a wavelength of 550 nm. The term “target radial PSD” refers to the result computed from Equation 6. Plots of both target radial PSDs and radial PSDs described herein may be as a function of both scattering angle (θₛ) or spatial frequency k, with the understanding that Equation 4 can used convert such values assuming a wavelength of 550 nm.

In embodiments, the plurality of surface features 26 are structured so that H(x,y), when input into Equation 6, substantially matches a target radial PSD. An example family of target radial PSDs that can be used to design the scattering region 20 can be expressed as

$$PSD ∼ {( \frac{{k}_{max} - k}{{k}_{max} - {k}_{peak}} )}^{α} \qquad ( 7 )$$

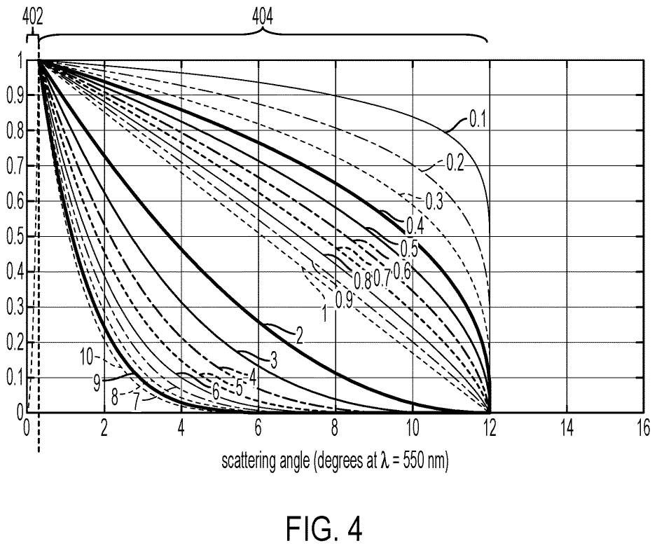

in the second range of scattering angles 404 (see FIG. 4), where α is an exponential decay parameter, kₘₐₓ is a spatial frequency associated with a non-zero scattering angle θₘₐₓ at which the target radial PSD is equal to zero, and kₚₑₐₖ is a spatial frequency associated with a peak angle θₚₑₐₖ at which the target radial PSD has a peak value. Assuming a wavelength of 550 nm, different values for the parameters α, θₘₐₓ, and θₚₑₐₖ can be used to generate target radial PSDs that provide different performance attributes.

FIG. 4 depicts a plot of a plurality of target radial PSDs generated using a plurality of different values for α, with θₘₐₓ=12.0° and θₚₑₐₖ=0.3. The target radial PSDs comprise a first range of scattering angles 402 in which the target radial PSDs increase approximately linearly in proportion to the scattering angle. The first range of scattering angles 402 extends up to a peak angle θₚₑₐₖ where the target radial PSD has a peak value. The target radial PSDs also comprise a second range of scattering angles 404 at scattering angles greater than θₚₑₐₖ in which the target radial PSDs decrease in accordance with Equation 6 at a rate that is determined by α. Radial PSDs with low a values (less than 1) are generally greater at higher spatial frequency (or scattering angles) than radial PSDs with higher values of a (greater than 1). As a result, lower a values generally provide superior sparkle performance than radial PSDs with higher alpha values. Lower a values, however, generally result in more pronounced color artifacts, where visible color separation can be introduced into light through scattering. Selection of an appropriate target radial PSD for a given application represents a tradeoff of various performance attributes, as will be described in greater detail herein.

Once a suitable target radial PSD is identified, the target radial PSD can be used to determine a phase distribution

$$ϕ ( x , y ) = \frac{2 π}{λ} 2 H ( x , y )$$

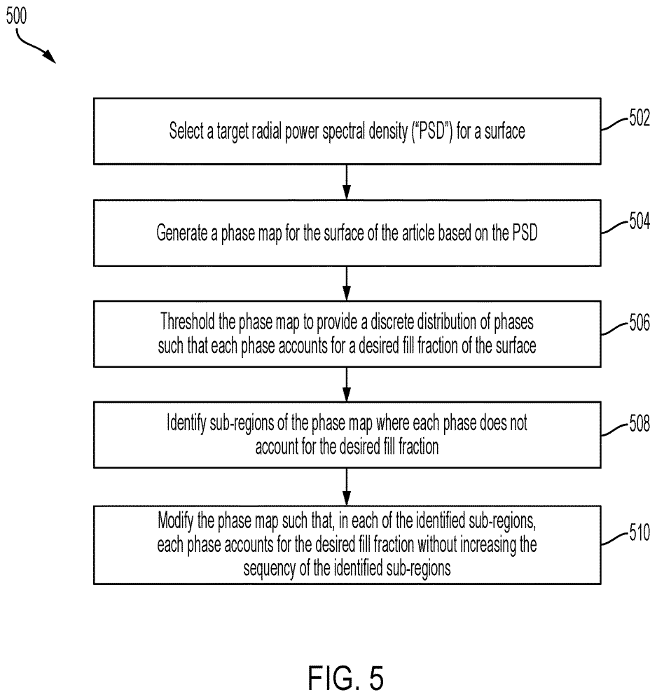

for the first major surface 18 using the methods described herein. FIG. 5 depicts a flow diagram of an example method 500 of determining a pattern for the plurality of surface features 26 of the scattering region 20. Various components depicted in FIGS. 1-4 will be referenced to aid in the description of the method 500. The method 500 may be used to form any number of anti-glare surfaces and that the depicted scattering region 20 may be formed via alternative methods.

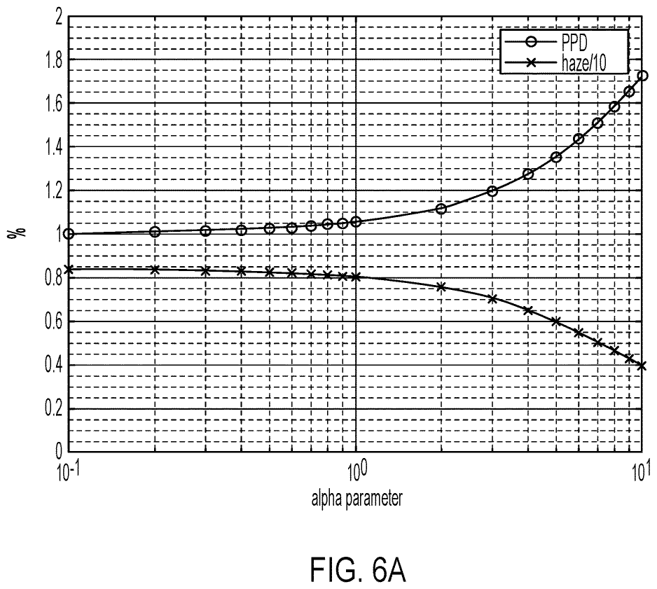

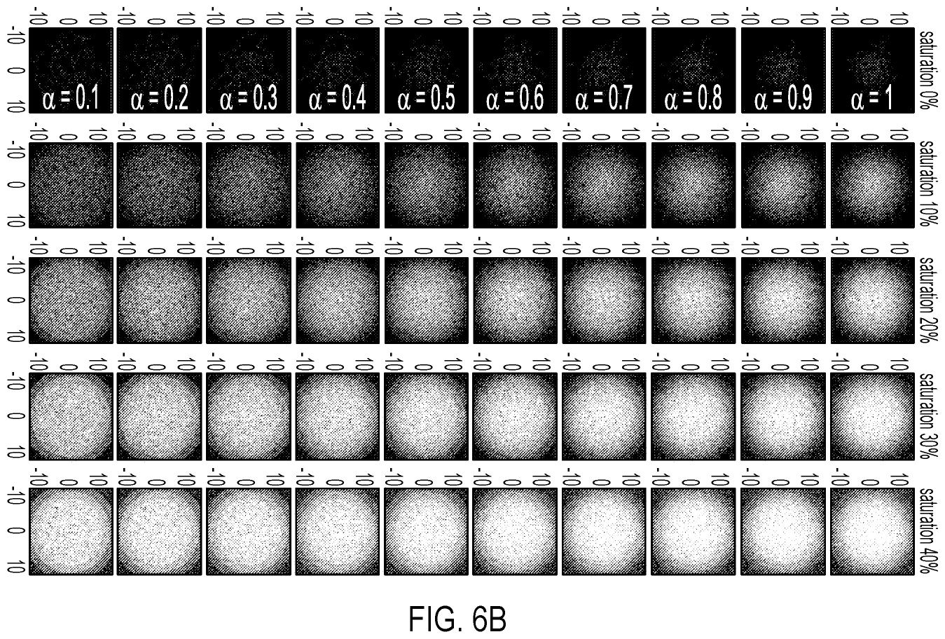

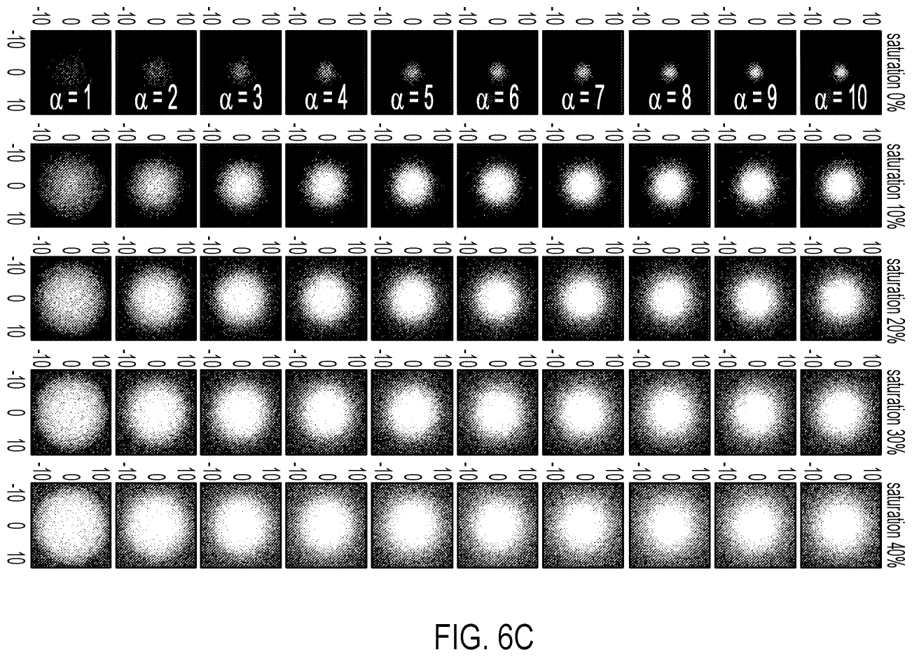

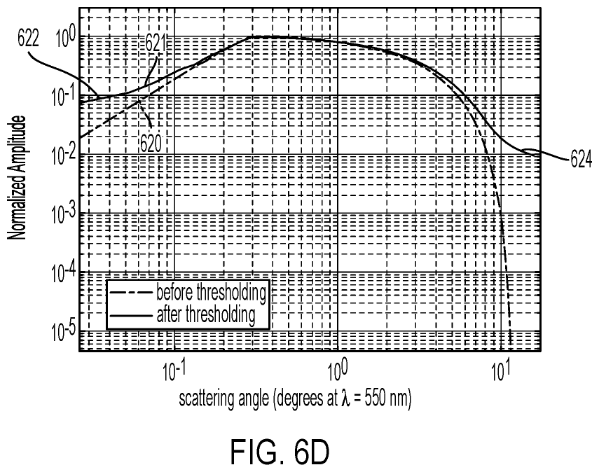

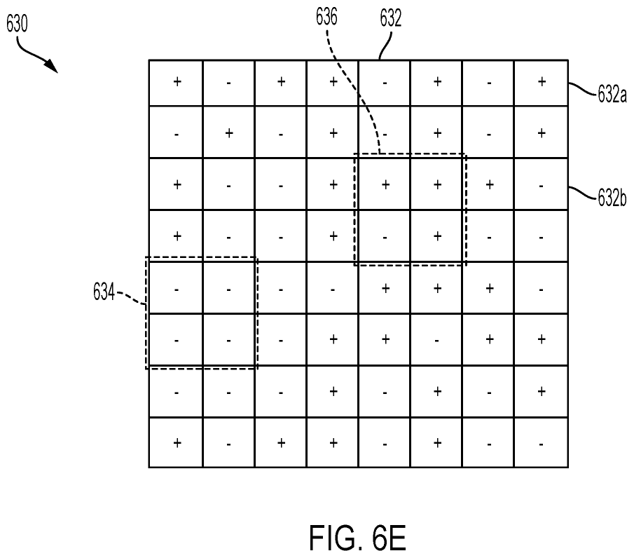

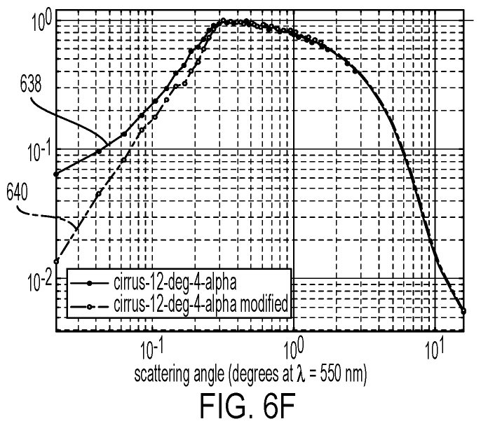

At block 502, a target radial PSD for the scattering region 20 is selected. The target radial PSD may be formulated by selecting values for the parameters α, θₘₐₓ, and θₚₑₐₖ based on performance attributes desired for the particular application. For example, FIG. 6A depicts a plot of modelled transmission haze and sparkle performance for articles fabricated to have the radial PSDs depicted in FIG. 4, assuming an etch depth of 140 nm. As shown, generally, as the a value increases, the expected sparkle increases, while the expected transmission haze decreases. Applications demanding relatively low levels of haze would therefore require alpha values of greater than 1, with the understanding that such high alpha values will generally result in sparkle that is greater than 1.0%. Another consideration for parameter selection is color artifact performance. FIGS. 6B and 6C depict qualitative simulated color appearance of reflected light with various levels of detector saturation. The x and y axes in the various plots in FIGS. 6B and 6B are scattering angle broken up into θₓ and θ_{y} components dependent on the azimuthal angle Φ (see FIG. 1). FIG. 6B depicts the simulated color appearance for values of a ranging from 0.1 to 1 and FIG. 6C depicts the simulated color appearance for values of α ranging from 1.0 to 10.0. As shown, surfaces with low α values show pronounced color boundary that gets less visible as α increases. For a values above 4, the appearance does not change significantly. As such, for applications where reflected color appearance of the article 10 is an important consideration, α values of 4 or 5 may provide a favorable balance of color artifact or sparkle performance (exhibiting sparkle that is less than or equal to 1.5% or less than or equal to 1.4%).

The parameter θₘₐₓ generally determines the magnitude of the target radial PSD at relatively large scattering angles. As will be described herein with respect to the Examples, when compared with target radial PSDs with low θₘₐₓ values (less than 10), target radial PSDs having high values of θₘₐₓ (greater than 10) may be associated with superior sparkle performance, at the expense of inferior washout performance. θₘₐₓ values between 2 and 5 may be selected if superior washout performance is desired (e.g., with the washout metric at either of the lighting conditions described herein being greater than or equal to 0.6, 0.65, 0.7, or even 0.75), while θₘₐₓ values of greater than 20 may be selected if specular reflectance reduction is the chief concern. θₚₑₐₖ (values of less than 10 (e.g., greater than or equal to 0.2° and less than or equal to 0.8°, greater than or equal to 0.3° and less than or equal to 0.5°) have been found to provide favorable haze performance without significantly impacting other performance attributes.

Referring back to FIG. 5, after the target radial PSD is formulated, at block 504, a phase map is generated for the scattering region 20 based on the target radial PSD. In embodiments, an inverse Fourier transform of the target radial PSD may be used to generate the phase map. Such an approach may generally produce a complex-valued phase map that is non-binary (and thus not consistent with a surface with the plurality of first regions and 28 and the plurality of second regions 30 depicted in FIG. 3). Non-binary phases are problematic in that certain existing production processes, such as the etching methods described herein, are not capable of producing such structures. Accordingly, at block 506, a threshold is applied to the phase map such that discrete regions (“pixels”) of the phase map form a discrete distribution of phases. The imaginary terms of the phases generated may be discarded and the threshold may be applied to the real values such that pixels having an average value below the threshold are assigned a first phase (e.g., π/2) and pixels having an average value above the threshold are assigned a second phase (e.g., −π/2). In embodiments the value for the threshold is selected such that an equal number of pixels are calculated to have a first phase and a second phase (e.g., each phase occupies 50% of the surface area of the scattering region). The pixel size may be selected based on an estimated minimum feature size achievable via the etching process described herein. In embodiments, the pixel size is greater than or equal to 200 nm (e.g., greater than or equal to 300 nm, greater than or equal to 400 nm, greater than or equal to 500 nm, greater than or equal to 600 nm, greater than or equal to 700 nm, greater than or equal to 800 nm, greater than or equal to 900 nm, greater than or equal to 1000 nm).

An issue created by such thresholding to create a discrete distribution of phases compatible with etching processes is that the thresholding operation changes the spatial frequency content of the radial PSD. FIG. 6D depicts a plot of a target radial PSD 620 prior to thresholding and a second radial PSD 621 computed from a phase distribution after thresholding. As shown, the second radial PSD 621 contains a first elevated segment 622 and a second elevated segment 624 where the second radial PSD 621 is higher than the target radial PSD 620. The ability to correct the second elevated segment 624 is limited by the step-like shape of the features. However, the first elevated segment 622 may be corrected using high-pass filtering operations.

It is believed that the first elevated segment 622 may be at least partially corrected by ensuring sub-regions of the phase map have phase fill fractions that are consistent with those associated with the entire scattering region 20. Accordingly, referring again to FIG. 5, at blocks 508 and 510, sub-regions of the phase map where each phase does not account for the desired fill fraction are identified and subsequently modified such that, in each of the identified sub-regions, each phase accounts for the desired fill fraction. To illustrate, in an example where the scattering region 20 comprises two phases with each phase having a 50% fill fraction, the phase map may be corrected by ensuring that sub-regions also have 50% fill fractions of each phase. Such local 50% fill fractions of each phase in each sub-region may be achieved by flipping the phase of certain pixels (e.g., from the first phase to the second phase or vice-versa) so as to decrease the sequency of that sub-region. The basis for such an operation can be understood based on Hadamard transforms, which are orthogonal expansion in terms of orthogonal Walsh functions. The Hadamard transform V of a vector v is an expansion in terms of Walsh functions (W(N, p)ₙ):

$${v}_{n} = {\sum }_{k = 1}^{{2}^{N}} {{v}^{︶}}_{k} {W ( N , p )}_{n} . \qquad ( 8 )$$

For a given N, the Walsh functions are ordered by the number of times the value of the function changes from +1 to −1. When plotted over a range of values from 0 to 2^{N}, a Walsh function having a value p=2^{m} (where m is greater than 0) will alternate with a half-period of 21^{N} (and therefore has a “sequency” of 2^{|N-m|}). Walsh functions where p=1 are a constant and have only a zero-frequency component. The Walsh functions are orthogonal in the frequency domain. This means that Walsh functions with p=2^{m}, with m>0, have no zero-frequency component. Indeed, it can be shown, that, for each Walsh function with p=2^{m}, with m>0, do not have any frequency content less than 2^{m-1}. That is, the subset of Walsh Functions with p=2^{m}, with m>0, have an increasing lower-frequency limit. In view of this, it can be concluded that an image with a Hadamard transform containing no frequencies below 2^{m-1} also does not contain the sequency 1, 2, 4, 8, . . . 2^{m} Walsh functions. That is, for a given image, the absence of any subset of the W(N, 2^{m}) Walsh functions in a Hadamard transform of an image is a necessary, but not sufficient, condition for the absence of low frequency components. This serves as a theoretical basis for the pixel phase flipping operation described herein.

In view of the foregoing, Applicant believes that the first elevated segment 622 can be at least partially corrected by flipping pixels to achieve localized fill fractions of 50% in various sub-regions of the pixel map in a way so as to decrease the sequency of the phase map. This operation can be performed by an algorithm that scans the pixel map generated through random phase generation and thresholding with a predetermined block-size (e.g., containing a predetermined array of x by y pixels). The block size may start in an initial position on the phase map (e.g., such that a corner of the block is aligned with a corner of the phase map), analyze the pixels contained in the block to determine the fill fraction of each block, and compare the local fill fraction of the block with the value for the entire scattering region 20 (which is 50%). If the local fill fraction matches the fill fraction associated with the entire scattering region 20, the algorithm may analyze a new block (e.g., by moving the block of analysis by one pixel in the x or y directions depicted in FIG. 2).

If the local fill fraction does not match the fill fraction associated with the entire scattering region 20, the algorithm identifies sub-arrays of pixels within the block that are out of conformance with the desired fill fraction of the block and flips the phase value of one or more pixels within at least one of the sub-arrays such that the block has the desired fill fraction. Pixels are only flipped in a given sub-array if doing so would tend to reduce the local sequency within the block. An example is depicted in FIG. 6E, which depicts a block 630 of a phase map generated via iterative phase retrieval and thresholding. The block 630 comprises an 8×8 array of pixels 632. The size of the block 630 is selected based on the Hadamard transform analysis described above. As discussed above, a Walsh function W(N, 2^{m}) is constant over adjacent blocks of length 2^{N-m} (in one dimension). Given this, if the local fill fraction of every block of this length is 50%, then the image cannot contain the Walsh function W(N, 2^{m}) or any Walsh function of lower sequency (i.e., any of the Walsh functions W(N, 1) to W(N, 2^{m-1}). Put differently, to achieve a 50% local fill fraction on a certain scale means that you have to have variation in the pattern with a smaller period than that scale. If the block size is relatively small, the phase map varies with smaller periods (has greater higher frequency content) and will tend to scatter more light at higher scattering angles. If the block size is very large, it has been found that this condition does not reduce the radial PSD at low scattering angles to a significant extent. In embodiments, the block size is around 60 μm×60 μm (e.g., from 25 μm×25 μm to 125 μm×125 μm). It has been found that this size is small enough to reduce low frequency content in the radial PSD without changing θₘₐₓ to a significant degree as a result of the local phase map correction.

In the block 630, pixels 632a assigned to have a first phase value are denoted a “+” and pixels 632b assigned to have a second phase value are denoted a “−”. An analysis of the phase values in the block 630 reveals that the block has two more of the pixels 632b than the pixels 632a. Accordingly, to achieve a desired 50% fill fraction for the block 630, one of the pixels 632b needs to be converted to a pixel 632a. The pixel 632b for conversion is selected to avoid increasing the high frequency content of the phase map. To illustrate, a first sub-array 634 of the block 630 comprises four of the pixels 632b having the second phase value and second sub-array 636 comprises three of the pixels 632a having the first phase value and one of the pixels 632b. Converting one of the pixels 632b in the first sub-array 634 would tend to increase the high frequency content of the phase map, as it would decrease the area over which the phase map is at a constant value. Converting the pixel 632b in the second sub-array 636 to one of the pixels 632a would tend to reduce the high frequency content of the phase map by increasing the area of which the phase map is at a constant value. Accordingly, in embodiments, the algorithm may convert phase values of pixels by identifying a 2×2 sub-array containing only a single pixel with the phase that needs to be converted (the second phase value in the example depicted in FIG. 6A) to ensure a 50% fill fraction in the block, and converting the phase value associated with that single pixel.

FIG. 6F depicts a plot of an un-modified radial PSD 638 post thresholding and a modified radial PSD 640 post thresholding. The depicted PSDs were generated based on Equation 7 with α=4, θₚₑₐₖ=0.3°, and θₘₐₓ=12°. To generate the un-modified radial PSD 638, a phase map was generated to which thresholding was applied to achieve a binary phase map with 50% fill fraction for the phases. To generate the modified radial PSD 640, the phase map used to generate the un-modified radial PSD 638 was modified to achieve local 50% over 96 μm by 96 μm blocks (representing 8×8 pixels) according to the method described herein.

As shown, the modified radial PSD 640 is less than the un-modified radial PSD 638 at low scattering angles, particularly scattering angles less than 0.1°. For example, as shown, the modified radial PSD 640 is 10% of the peak value at θₚₑₐₖ at a scattering angle of greater than 0.05° (at approximately 0.07°), where the un-modified radial PSD 638 is 10% of the peak value at a scattering angle less than 0.05°. The modified radial PSD 640 is about 2% of the peak value at specular, whereas the un-modified radial PSD 638 has a minimum value of approximately 6.5% of the peak value at specular. Additionally, it does not appear that the modifications to the phase mask materially altered the radial PSD at scattering angles above θₚₑₐₖ. Such results demonstrate the efficacy of the phase mask modification methods described herein and also that such modifications can result in reduced small angle scattering.

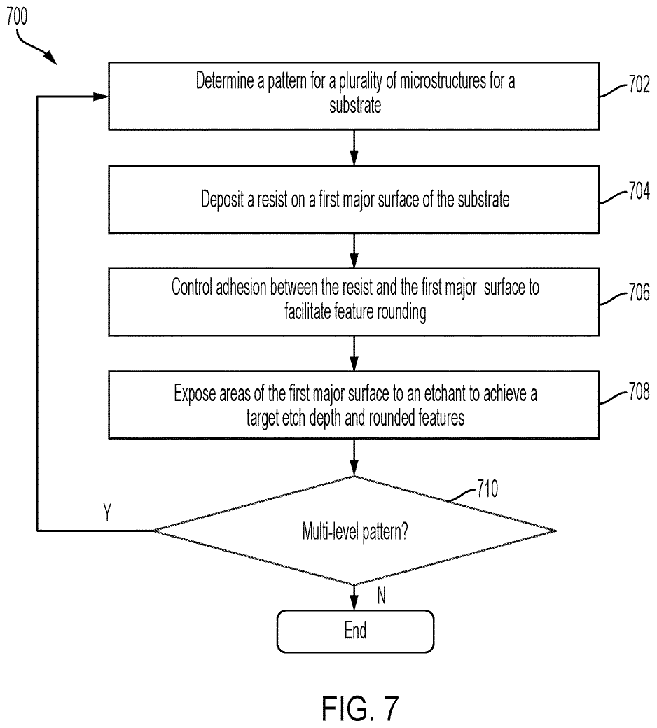

FIG. 7 depicts a flow diagram of an example method 700 of fabricating the article 10, according to an example embodiment of the present disclosure. Reference to various components and processes depicted in FIGS. 1-6F will be made to aid in describing the method 700. The method used to form the article 10 is not particularly limiting and that any suitable method may be used. At block 702, a pattern for the plurality of surface features 26 is determined. In embodiments, the pattern is determined via performing the method 500 described herein with respect to FIG. 5, by selecting a target radial PSD, generating a phase map based on the target radial PSD, thresholding the generated phase map, and modifying the phase map to provide localized fill fractions for the phases in sub-regions of the phase map.

At block 704, a resist is disposed on the first major surface 18 and patterned. The nature of the deposition and patterning of the resist may vary depending on the fabrication technique used. In embodiments, various nanoimprint or photolithographic techniques may be used to deposit and pattern the resist layer. In such embodiments, a minimum feature size (e.g., minimum linear dimension) associated with the plurality of surface features 26 may be set to at least 400 nm, (e.g., greater than or equal to 500 nm, greater than or equal to 600 nm, greater than or equal to 700 nm, greater than or equal to 800 nm, greater than or equal to 900 nm, greater than or equal to 1.0 μm, greater than or equal to 1.5 μm, greater than or equal to 2.0 μm, greater than or equal to 2.5 μm, greater than or equal to 5.0 μm) to facilitate use of existing resist application and patterning techniques. In embodiments, for example, the resist may be formed using thermoplastic nanoimprint lithography, and the resist may be formed of a thermoplastic polymer that is spin-coated onto the substrate 12 and subsequently imprinted via a mold to form a first pattern that at least partially corresponds to the pattern for the plurality of surface features 26 on the first major surface 18. The resist may be subsequently thermally cured to form an etching mask. Other methods of forming the resist (e.g., Gravure offset printing, other printing techniques) are also contemplated and within the scope of the present disclosure.

Photolithography (e.g., photo imprint nanolithography, optical photolithography) techniques may also be used, and the resist may be deposited onto the first major surface 18 via a suitable application method (e.g., spin coating). In such embodiments, a mask comprising a first pattern at least partially corresponding to the pattern determined for the plurality of surface features 26 is aligned with the first major surface 18, and the resist may be exposed to radiation from a suitable light source (e.g., UV radiation) to cause the resist to cure and form an etching mask. The resist may subsequently be developed such that portions of the first major surface 18 are left exposed through the cured resist. Any suitable photolithographic technique may be used to pattern the resist.

At Block 706, during the deposition of the resist on the first major surface 18, adhesion between the resist and the first major surface 18 is controlled to facilitate feature rounding during etching. Such adhesion can control undercutting in the etching process, which can change the shape of the edges of the plurality of surface features 26. Particularly, such adhesion control can increase the width w of the transition surfaces 40 described herein with respect to FIG. 3B to above 1.0 μm, to aid in reducing the radial PSD at relatively high scattering angles above θₚₑₐₖ. In embodiments, an adhesion promoter (e.g., HexaMethylDiSilazane (HDMS) or N,N-dimethyl-N-(3-(trimethoxysilyl)propyl)octadecan-1-ammonium chloride, YSAM C18) is applied to the first major surface 18 prior to the resist being applied. Controlling chemistry of the adhesion promotor (in terms of hydrophobic groups) can provide a degree of control over undercutting during etching and feature rounding. Alternatively or additionally, the amount of adhesion promoter applied to the surface can also effect the amount of adhesion. Adhesion promoter can also be removed from the first major surface 18 prior to applying a resist thereto to modify adhesion of the resist. Applicant has found that any process to modify the surface chemistry and water contact angle of the first major surface 18 can modify the adhesion with the resist and therefore effect the amount of feature rounding. Any suitable technique to reduce adhesion between the resist and first major surface 18 may be used to effectuate feature rounding. In embodiments, any of the adhesion promoters described in U.S. Pat. No. 9,884,782, filed on Apr. 1, 2015 and hereby incorporated by reference in its entirety, can be applied to the glass prior to deposition of a resist, such that the substrate 12 exhibits a water contact angle that is greater than or equal to 400 and less than or equal to 70° (e.g., greater than or equal to 450 and less than or equal to 60°, greater than or equal to 48° and less than or equal to 52°) after application of the adhesion promoter. Such water contact angles have been found to be associated with suitable amounts of feature rounding.

At block 708, exposed areas of the first major surface 18 (through the cured and patterned resist) are exposed to a suitable etchant for a suitable etching period determined based on a target etch depth. Each area of the first major surface 18 that is exposed through the patterned resist formed in the block 504 may directly contact the etchant, which may degrade the substrate 12 and remove material therefrom to form regions on the first major surface 18 that are disposed at a diminished height relative to the imaginary base plane 35 as compared to areas of the first major surface 18 that are covered by the patterned resist. In embodiments, the etchant that contacts the first major surface 18 is an HF/HNO₃ etchant. In embodiments, the etchant consists of hydrofluoric acid (HF, 49 w/w %) and nitric acid (HNO₃, 69 w/w %) combinations with 0.1-5 v/v % HF and 0.1-5 v/v % HNO₃. Typical concentrations used to achieve the etching depths discussed herein are 0.1 v/v % HF/1 v/v % HNO₃ to 0.5 v/v % HF/1 v/v % HNO₃ solutions. In embodiments, the etching can be carried out using a dip or spray etching process from room temperature to about 45° C.

Block 710 is a decision block where it is determined whether scattering region 20 is to incorporate more than two heights. With reference to FIG. 3A, in embodiments, the plurality of surface features 26 can include a plurality of third regions 32 that are disposed at a third height h₃ relative to the imaginary base plane 35 and a plurality of fourth regions 34 that are disposed at a fourth height h₄ relative to the imaginary base plane 35. The third height h₃ may be the same or may differ from the fourth height h₄ by a second etch depth that may be the same or different than the etch depth that differentiates h₁ from h₂. Incorporating the plurality of third regions 32 and the plurality of fourth regions 34 can provide certain performance improvements relative to single etch designs, such as improved specular reflectance reduction and reduced DOI. The multiple levels enable interferometric suppression of specular reflection over a broader range of optical wavelengths. Performance attributes for multi-level designs will be described in more detail herein with respect to the Examples.

If multiple-levels are desired, the method 700 may revert back to block 702 to determine a pattern for the additional etching step. In embodiments, the same target radial PSD may be used to generate the pattern for the second etch as that was used in the first etch step. However, when the resist is disposed on the first major surface 18, the substrate 12 may be rotated by an angle (e.g., 90°, 180°, or any other angle) so that the pattern is applied to the first major surface 18 at a different orientation in the second etch as compared to the first etch. In embodiments, a different target radial PSD may be used to generate the pattern for the second etch than what was used in the first etch.

### Substrate Properties

Various properties of the substrate 12 will now be described, according to embodiments of the present disclosure.

In embodiments, the substrate 12 is a glass substrate or a glass-ceramic substrate. In embodiments, the substrate 12 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 12 is selected from the group consisting of aluminosilicate glass, a borosilicate glass, and a phosphosilicate glass. In other implementations, the bulk composition of the substrate 12 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 12 is a glass-based substrate, including, but not limited to, glass-ceramic materials that comprise a glass component at about 90% or greater by weight and a ceramic component. In other implementations of the article 10, the substrate 12 can be a polymer material, with durability and mechanical properties suitable for the development and retention of the scattering region 20.

In embodiments, the substrate 12 has a bulk composition that comprises an alkali aluminosilicate glass that comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio (Al₂O₃ (mol %)+B₂O₃ (mol %))/Σ alkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂O₃ (mol %)+B₂O₃ (mol %))/Σ alkali metal modifiers (mol %)>1, where the modifiers are alkali metal oxides.

In embodiments, the substrate 12 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO.

In embodiments, the substrate 12 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≤Li₂O+Na₂O+K₂O≤20 mol % and 0 mol %≤MgO+Ca≤10 mol %.

In embodiments, the substrate 12 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≤SiO₂+B₂O₃+CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂O₃≤2 mol %; 2 mol %≤Na₂O—Al₂O₃≤6 mol %; and 4 mol % (Na₂O+K₂O)—Al₂O₃≤10 mol %.

In embodiments, the substrate 12 has a bulk composition that comprises SiO₂, Al₂O₃, P₂O₅, and at least one alkali metal oxide (R₂O), wherein 0.75>[(P₂O₅ (mol %)+R₂O (mol %))/M₂O₃ (mol %)]≤1.2, where M₂O₃=Al₂O₃+B₂O₃. In embodiments, [(P₂O₅ (mol %)+R₂O (mol %))/M₂O₃ (mol %)]=1 and, in embodiments, the glass does not include B₂O₃ and M₂O₃=Al₂O₃. The substrate 12 comprises, in embodiments: about 40 to about 70 mol % SiO₂; 0 to about 28 mol % B₂O₃; about 0 to about 28 mol % Al₂O₃; about 1 to about 14 mol % P₂O₅; and about 12 to about 16 mol % R₂O. In some embodiments, the glass substrate comprises: about 40 to about 64 mol % SiO₂; 0 to about 8 mol % B₂O₃; about 16 to about 28 mol % Al₂O₃; about 2 to about 12 mol % P₂O₅; and about 12 to about 16 mol % R₂O. The substrate 12 may further comprise at least one alkaline earth metal oxide such as, but not limited to, MgO or CaO.

In some embodiments, the substrate 12 has a bulk composition that is substantially free of lithium; i.e., the glass comprises less than 1 mol % Li₂O and, in other embodiments, less than 0.1 mol % Li₂O and, in other embodiments, 0.01 mol % Li₂O, and in still other embodiments, 0 mol % Li₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In embodiments, the substrate 12 has a bulk composition that comprises, consists essentially of or consists of a glass composition, such as Corning® Eagle XG® glass, Corning® Gorilla® glass, Corning® Gorilla® Glass 2, Corning® Gorilla® Glass 3, Corning® Gorilla® Glass 4, or Corning® Gorilla® Glass 5.

In embodiments, the substrate 12 has an ion-exchangeable glass composition that is strengthened by either chemical or thermal means that are known in the art. In embodiments, the substrate 12 is chemically strengthened by ion exchange. In that process, metal ions at or near the first major surface 18 of the substrate 12 are exchanged for larger metal ions having the same valence as the metal ions in the glass substrate. The exchange is generally carried out by contacting the substrate 12 with an ion exchange medium, such as, for example, a molten salt bath that contains the larger metal ion. The metal ions are typically monovalent metal ions, such as, for example, alkali metal ions. In one non-limiting example, chemical strengthening of a substrate 12 that contains sodium ions by ion exchange is accomplished by immersing the substrate 12 in an ion exchange bath comprising a molten potassium salt, such as potassium nitrate (KNO₃) or the like. In one particular embodiment, the ions in the surface layer of the substrate 12 contiguous with the first major surface 18 and the larger ions are monovalent alkali metal cations, such as Li⁺ (when present in the glass), Na⁺, K⁺, Rb⁺, and Cs⁺. Alternatively, monovalent cations in the surface layer of the substrate 12 may be replaced with monovalent cations other than alkali metal cations, such as Ag⁺ or the like.

In such embodiments, the replacement of small metal ions by larger metal ions in the ion exchange process creates a compressive stress region in the substrate 12 that extends from the first major surface 18 to a depth (referred to as the “depth of layer”) that is under compressive stress. This compressive stress of the substrate 12 is balanced by a tensile stress (also referred to as “central tension”) within the interior of the substrate 12. In some embodiments, the first major surface 18 of the substrate 12 described herein, when strengthened by ion exchange, has a compressive stress of at least 350 MPa, and the region under compressive stress extends to a depth, i.e., depth of layer, of at least 15 m below the first major surface 18 into the thickness 21.

Ion exchange processes are typically carried out by immersing the substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt, such as, but not limited to, nitrates, sulfates, and chlorides, of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a substrate 12 having an alkali aluminosilicate glass composition, result in a compressive stress region having a depth (depth of layer) ranging from about 10 m up to at least 50 m, with a compressive stress ranging from about 200 MPa up to about 800 MPa, and a central tension of less than about 100 MPa.

As the etching processes that can be employed to create the scattering region 20 of the substrate 12 can remove alkali metal ions from the substrate 12 that would otherwise be replaced by a larger alkali metal ion during an ion exchange process, a preference exists for developing the compressive stress region in the article 10 after the formation and development of the scattering region 20.

### Examples

Embodiments of the present disclosure may be further understood in view of the following examples.

A first set of examples was constructed via performance of the methods 500 and 700 described herein with respect to FIGS. 5 and 7. Particularly, a target radial PSD was formulated using α values of 4 and 5, θₚₑₐₖ values of 0.3 and 0.5, and θₘₐₓ values of 4, 8, 12, 16, and 32. The examples were formed in a 0.7 mm thick pieces of Corning AutoGrade® Glass. The method 500 was performed on each of the examples to determine a pattern for resist deposition (a 50% fill fraction for each of the heights was used). The method 700 was followed to etch the samples through the resist to various etch depths (etch depths were measured with a 2D tactile profilometer and subsequently validated with white light interferometry over a 1×1 mm area). The target radial PSDs and etch depths are summarized in the Table 1 below (Examples marked with a “*” include feature rounding via the block 706 in the method 700). DOI values are reported in gloss units in accordance with ASTM E430.

TABLE 1

| | | Θₚₑₐₖ | Θₘₐₓ | etch | | PPD | | | | |
|---|---|---|---|---|---|---|---|---|---|---|
| # | α | (deg) | (deg) | (nm) | haze % | @140PPI % | c-DOI | Rs | Washout₁ | Washout₂ |
| 1 | 4 | 0.3 | 4 | 110 | 1.92 | 2.21 | 87.82 | 22.13 | — | — |
| 2 | 4 | 0.3 | 4 | 145 | 2.95 | 2.76 | 52.01 | 8.63 | 0.59 | 0.44 |
| 3 | 4 | 0.5 | 4 | 135 | 2.71 | 2.5 | 66.2 | 9.99 | — | — |
| 4 | 4 | 0.5 | 4 | 141 | 3.38 | 2.6 | 52.43 | 7.73 | 0.55 | 0.42 |
| 5* | 4 | 0.5 | 4 | 146 | 1.05 | 2.22 | 78.81 | 14.63 | 0.8 | 0.73 |
| 6* | 4 | 0.5 | 4 | 264 | 0.58 | 2.63 | 81.51 | 11.85 | 0.801 | 0.728 |
| 7* | 4 | 0.5 | 4 | 259 | 0.72 | 2.72 | 83.83 | 14.85 | 0.783 | 0.703 |
| 8* | 4 | 0.5 | 4 | 164 | 1.23 | 2.45 | 69.2 | 10.51 | 0.758 | 0.689 |
| 9 | 4 | 0.5 | 4 | 145 | 3.43 | 2.72 | 45.55 | 6.86 | — | — |
| 10 | 4 | 0.3 | 8 | 145 | 4.82 | 1.67 | 63.89 | 6.58 | — | — |
| 11 | 4 | 0.3 | 8 | 148 | 5.71 | 1.67 | 63.78 | 6.74 | 0.47 | 0.33 |
| 12 | 4 | 0.3 | 8 | 128 | 7.23 | 1.8 | 72.86 | 6.05 | 0.46 | 0.33 |
| 13 | 4 | 0.3 | 8 | 142 | 6.03 | 1.66 | 64.97 | 5.45 | 0.44 | 0.32 |
| 14 | 4 | 0.3 | 8 | 151 | — | — | — | | 0.43 | 0.29 |
| 15 | 4 | 0.3 | 8 | 152 | — | 1.64 | 62.21 | 5.44 | 0.43 | 0.27 |
| 16 | 5 | 0.3 | 12 | 164 | 8.86 | 1.32 | 80.09 | 6.02 | — | — |
| 17 | 5 | 0.3 | 12 | 175 | 10.4 | 1.35 | 87.49 | 8.59 | 0.35 | 0.21 |
| 18 | 5 | 0.3 | 16 | 149 | 8.1 | 1.32 | 69 | 5.28 | 0.38 | 0.26 |
| 19 | 5 | 0.3 | 16 | 133 | — | 0.97 | 92.12 | 10.52 | 0.31 | 0.22 |
| 20 | 5 | 0.5 | 32 | 161 | — | — | 76.0 | 3.65 | — | — |
| 21 | 5 | 0.5 | 32 | 157 | 11.8 | 0.81 | 78.4 | 4.1 | — | — |

As shown in the Table 1, a plurality of performance attributes for the samples were measured, including transmission haze, sparkle (PPD), coupled distinctness of image, specular reflectance (Rs) and a washout metric in two different configurations. The washout metric relates to how the scattering region 20 may impact display black level contrast in the presence of external light sources. Higher values for the washout metric are associated with superior performance. Samples with rounded features exhibit higher washout metric performance of greater than or equal to 0.68 (and in some cases greater than or equal to 0.70, greater than or equal to 0.75, or even greater than or equal to 0.80). More details regarding the measurement and computation of the washout metric are provided in greater detail herein. Various ranges for the performance attributes achieved for subsets of the first set of examples are provided in the Table 2 below.

TABLE 2

| | Θₚₑₐₖ | Θₘₐₓ | etch | | PPD | c-DOI | | | |
|---|---|---|---|---|---|---|---|---|---|
| α | (deg) | (deg) | (nm) | haze % | @140PPI % | % | Rs | Washout₁ | Washout₂ |
| 4 | 0.3 | 4 | 86-185 | 1.1-5.7 | 1.7-3.6 | 52-92 | 8.3-43.5 | ~0.58 | ~0.44 |
| 4 | 0.5 | 4 | 90-220 | 1.3-6.3 | 1.8-3.6 | 46-96 | 6.9-37.8 | ~.55 | ~.42 |
| 4 | 0.3 | 8 | 137-187 | 4.8-18.5 | 1.7-2.5 | 60-87 | 5.8-11.8 | | |
| 5 | 0.3 | 12 | 130-190 | 6.8-11.1 | 1.1-1.4 | 81-90 | 6.0-11.2 | | |
| 5 | 0.3 | 16 | 131-177 | 8.1-11.5 | 1.0-1.5 | 69-90 | 5.3-8.9 | | |
| 5 | 0.5 | 32 | 100-222 | 13.9-14.6 | 0.7-0.9 | 92-99 | 5.9-13.0 | | |
| 5* | 0.5 | 4 | 98-162 | .6-1.1 | 1.8-2.3 | 79-92 | 15-37 | .58-.80 | .44-.73 |

As shown in the Table 2, samples generated using target radial PSDs having relatively low θₘₐₓ values (e.g., with θₘₐₓ=4°) tended to exhibit superior transmission haze performance (in some cases providing transmission haze values that are less than or equal to 3.0%, less than or equal to 2.75%, less than or equal to 2.5%, less than or equal to 2.0%, less than or equal to 1.75%, less than or equal to 1.50%, less than or equal to 1.25%, less than or equal to 1.0%, or even less than or equal to 0.75%). However, samples generating using target radial PSDs with relatively high θₘₐₓ values (e.g., with θₘₐₓ=32°) tended to exhibit superior sparkle performance (in some cases less than or equal to 1.0%, less than or equal to 0.9%, less than or equal to 0.8%, less than or equal to 0.7%, less than or equal to 0.6%, or even less than or equal to 0.55%). The last row of in the Table 2 included some samples with feature rounding, which resulted in generally superior washout and haze performance compared with samples not including rounding but formed with the same target radial PSD.

The “washout” metric contained in Tables 1 and 2 was formulated to quantify the effects of glare events (e.g., exposure to sunlight) on the contrast and resolution of an incorporating display. Such a metric is useful to examine cover material performance for applications likely to be exposed to light from external light sources (e.g., automotive interior displays, outdoor displays). To quantify “washout,” a modulation transfer function (MTF) of an anti-glare surface is measured under various illumination conditions, and the average value of the MTF over a number of spatial frequencies is used to evaluate the effect of illumination conditions on display performance. The MTF at a particular spatial frequency f may be expressed as

$$MTF ( f ) = \frac{{MF}_{o u t} ( f )}{{MF}_{in ( f )}} , \qquad ( 9 )$$

$$where$$

$${MF}_{i} ( f ) = \frac{{{I}_{i} ( f )}_{max} - {{I}_{i} ( f )}_{min}}{{{I}_{i} ( f )}_{max} + {{I}_{i} ( f )}_{min}} , \qquad ( 10 )$$

and I(f)ₘₐₓ and I(f)ₘᵢₙ are the maximum and minimum intensities of an input or an output modulation image at the spatial frequency f. In this expression, MFᵢₙ represents the MF value associated with an input pattern being emitted through a sample cover material. The MFₒᵤₜ value represents the MF value when the cover material is disposed over the input pattern (e.g., from a display) and under the illumination condition being tested. Higher MTF values generally mean that the illumination condition has less of an effect on display performance (and therefore better performance of the scattering region of the cover material). In embodiments, MTF values of greater than or equal to 0.60 (e.g., greater than or equal to 0.65, greater than or equal to 0.70, greater than or equal to 0.75 greater than or equal to 0.76, greater than or equal to 0.77, greater than or equal to 0.78, greater than or equal to 0.79, greater than or equal to 0.80, greater than or equal to 0.81, greater than or equal to 0.82, greater than or equal to 0.83, greater than or equal to 0.84, greater than or equal to 0.85, greater than or equal to 0.86, greater than or equal to 0.87, greater than or equal to 0.88, greater than or equal to 0.89, greater than or equal to 0.90, greater than or equal to 0.91, greater than or equal to 0.92, greater than or equal to 0.93, greater than or equal to 0.94, and greater than or equal to 0.95) are preferred for a given illumination condition, indicating minimal degradation of display performance caused by exposure to the external light.

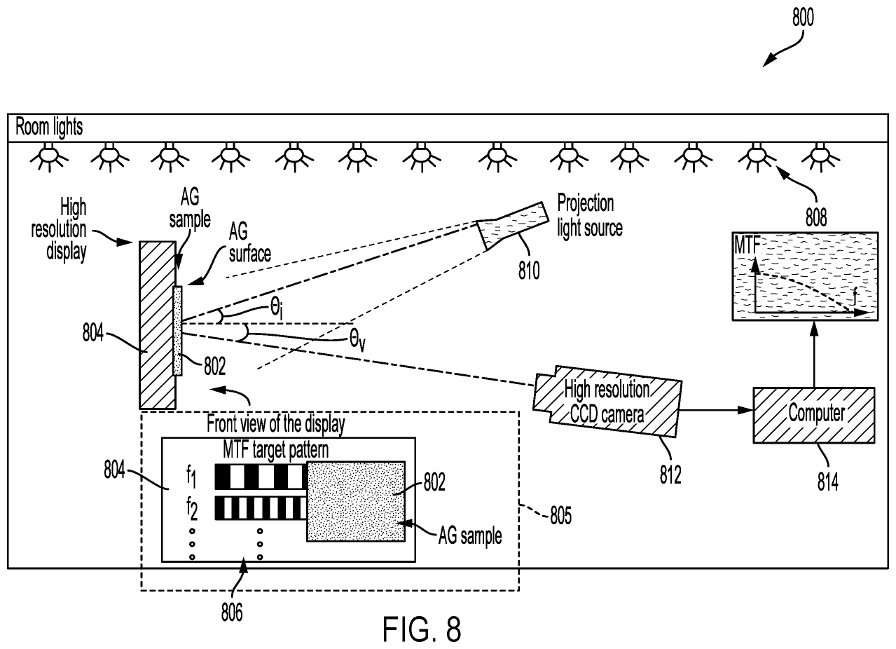

FIG. 8 schematically depicts an apparatus 800 for measuring the washout effect. As shown, a sample 802 (e.g., corresponding to the substrate 12 described herein) is placed over a display 804. The sample 802 is positioned so that the scattering region faces outward (not towards the display 804). As shown in the box 805 (which depicts a front view of the sample 802 and the display 804), the display 804 generates a plurality of target patterns 806 where the intensity of light emitted by the display 804 varies with a particular spatial frequency f. A plurality of first light sources 808 are distributed around the sample 802. The plurality of first light sources 808 (e.g., room lights) are configured to emit a relatively low intensity light to simulate the sample 802 encountering normal ambient conditions (e.g., room light). As reported herein, the plurality of first light sources 808 were configured to emit white light with 130 lux and a color temperature of 2100 k). A projection light source 810 is configured to emit a relatively high intensity light source to simulate sunlight illumination. The projection light source 810 is positioned such that light emitted thereby is incident on the sample with an angle of incidence θᵢ. In embodiments, the projection light source 810 is movable or otherwise adjustable so as to change the angle of incidence θᵢ. In embodiments, the projection light source 810 emits light over an emission area, such that light emitted by the projection light source 810 is incident on the sample 802 at a range of angles of incidence θᵢ.

A camera 812 is positioned to receive light scattered from the sample 802. The camera is positioned such that light scattered from the sample 802 will enter the camera 812 at a viewing angle θᵥ (or range of viewing angles). In embodiments, the camera 812 is movable or otherwise adjustable to change the viewing angle θᵥ. A computing system 814 receives an image generated by the camera 812 and analyzes the image to compute a plurality of MTF values for each of the plurality of target patterns 806 emitted by the display 804. For each of the target patterns 806, the computing system 814 may calculate an MTF value using Equations 9 and 10 and generate an output that measures the dependency of the MTF value on spatial frequency. The plurality of first light sources 808 and the projection light source 810 allow the MTF values to be measured under a plurality of different lighting conditions to determine the efficacy of the pattern on the sample 802 in reducing washout. When just the first light sources 808 are emitting light, a “room light washout” effect can be measured. When both the first light sources 808 and the projection light source 810 are emitting light, a “sunlight washout” effect can be measured.

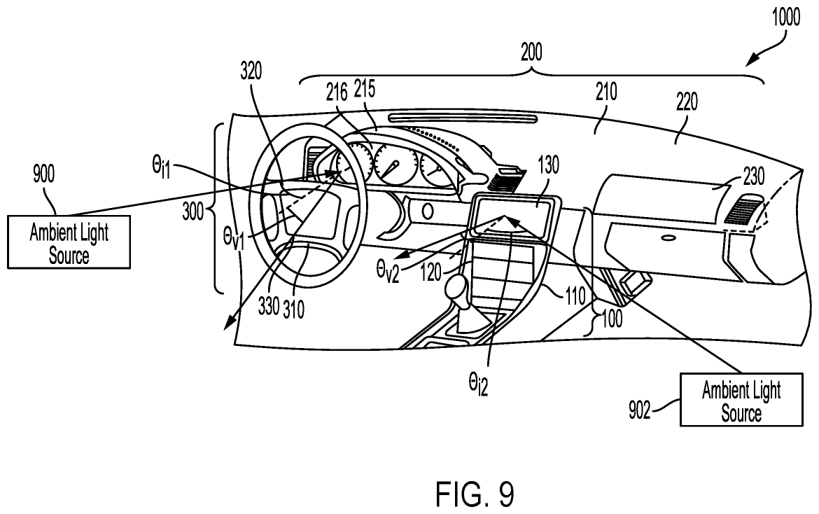

Such washout measurements may be particularly useful in evaluating the performance of cover materials for automotive interior displays. FIG. 9 shows a vehicle interior 1000 that includes three different vehicle interior systems 100, 200, 300, according to an exemplary embodiment. Vehicle interior system 1000 includes a center console base 110 with a surface 120 including a display 130. Vehicle interior system 200 includes a dashboard base 210 with a surface 220 including a display 230. The dashboard base 210 typically includes an instrument panel 215 which may also include display 216. Vehicle interior system 300 includes a dashboard steering wheelbase 310 with a surface 320 and a display 330. In one or more embodiments, the vehicle interior system may include a base that is an arm rest, a pillar, a seat back, a floorboard, a headrest, a door panel, or any portion of the interior of a vehicle that includes a surface. In embodiments, the displays 130, 230, 330 are flat and comprise cover glass with planar major surfaces. In embodiments, one or more of the displays 130, 230, 330 are curved, and the curved display may include curved cover glass that may be hot-formed or cold-formed to possess such curvature. For example, such embodiments may incorporate opaque layers formed of the photocurable inks described herein disposed on cold-formed glass substrates. Such cold-forming may involve any of the techniques described in U.S. Pre-Grant Publication No. 2019/0329531 A1, entitled “Laminating thin strengthened glass to curved molded plastic surface for decorative and display cover application,” U.S. Pre-Grant Publication No. 2019/0315648 A1, entitled “Cold-formed glass article and assembly process thereof,” U.S. Pre-Grant Publication No. 2019/0012033 A1, entitled “Vehicle interior systems having a curved cover glass and a display or touch panel and methods for forming the same,” and U.S. patent application Ser. No. 17/214,124, entitled “Curved glass constructions and methods for forming same,” which are hereby incorporated by reference in their entireties.

Various components of the vehicle interior 1000 may be subjected to illumination from various light sources. As depicted in FIG. 9, for example, a first ambient light source 900 may emit light that is transmitted through a first side window of the vehicle and incident on the display 216 with at an angle of incidence θᵢ₁. The display 216 may be oriented such that light scattered at a particular scattering angle θᵥ₁ will enter the driver's field of vision and distract the driver. A second ambient light source 902 may emit that is transmitted through a second side window of the vehicle and incident on the display 130 with at an angle of incidence θᵢ₂. The display 130 may be oriented such that light scattered at a particular scattering angle θᵥ₂ will enter the driver's field of vision and distract the driver. The first and second ambient light sources 900 and 902 may represent sunlight at various points in time. Indeed, the ISO 15002/SA 1757 standards specify a first condition where 45 k lux light (direct sunlight) is incident on the display 216 at an angle of 20° and scatters into the driver at a scattering angle of 0° (i.e., where θᵢ₁=200 and θᵥ₁=0°, associated with the “washout₁” metric herein) and a second condition where 45 k lux light (direct sunlight) is incident on the display 130 at an angle of 45° and scatters into the driver at a scattering angle of 20° (i.e., where θᵢ₂=450 and θᵥ₂=20°, associated with the “washout₂” metric herein). The apparatus 800 depicted in FIG. 8 enables such conditions to be tested for washout by varying the orientation of the sample 802 and adjusting the projection light source 810.

Using the apparatus 800 depicted in FIG. 8, the two conditions of ISO 15002/SA 1757 described herein were used to test a sample constructed in accordance with the methods described herein. An Apple® mini-iPad® 4 was used as the display 804. A Pixelink 3.1 MP PL-B776 was used as the camera 812. A collimated LED light source (emitting 45000 lux white light) was used at the projection light source 810 (made by Mightex Systems, model of LCS-6500-65-22). Multiple projection light sources were used and positioned so as to emit light incident on the sample 802 at angles of incidence of 20° and 45°. The sample 802 and camera 812 were also mounted on a rotation stage so as to render the viewing angle θᵥ and angle of incidence θᵢ adjustable for the two conditions. Lab room light was used as the first light sources 808 and was measured to have a luminance of 132 lux.

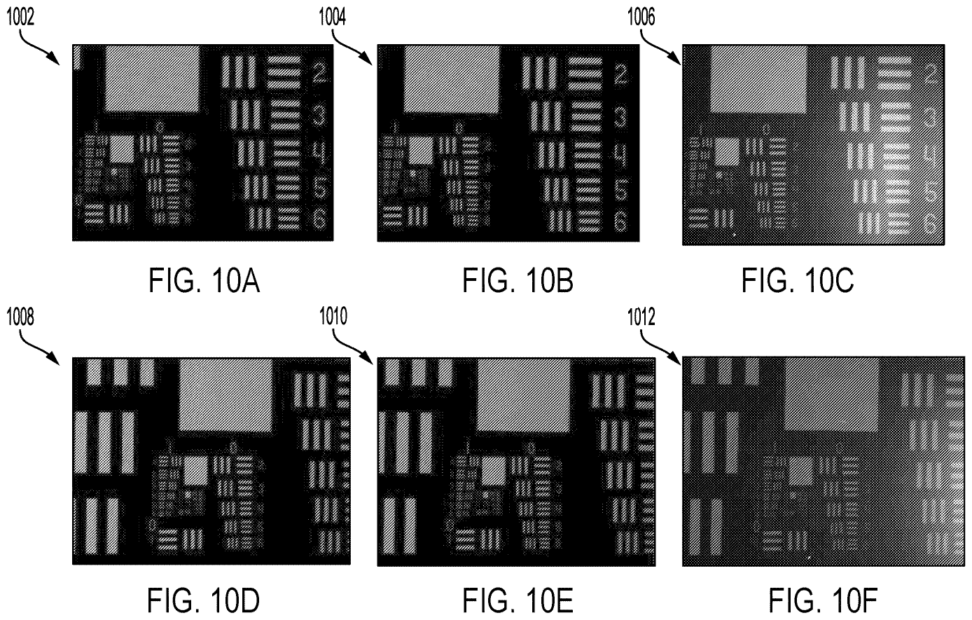

In a first set of measurements, the sample 802 had a standard AG surface treatment (by sandblasting the first major surface 18, referred to herein as “Counter Example 1”). The results are depicted in FIGS. 10A-10F. FIGS. 10A-10C depict the imaged patterns under the first condition described herein (i.e., where θᵢ₁=20° and θᵥ₁=0°). FIG. 10A depicts an image 1002 where the display 804 was uncovered by the sample 802 in a dark room. FIG. 10B depicts an image 1004 where the display 804 was covered by the sample 802 when only the first light sources 808 were emitting light (lab lights were turned on). FIG. 10C depicts an image 1006 where the display 804 was covered by the sample 802 and both the first light sources 808 and the projection light source 810 were emitting light. FIGS. 10D-10F depict the imaged patterns under the second condition described herein (i.e., where θᵢ₂=45° and θᵥ₂=20°). FIG. 10D depicts an image 1008 where the display 804 was uncovered by the sample 802 in a dark room. FIG. 10E depicts an image 1010 where the display 804 was covered by the sample 802 when only the first light sources 808 were emitting light (lab lights were turned on). FIG. 10F depicts an image 1012 where the display 804 was covered by the sample 802 and both the first light sources 808 and the projection light source 810 were emitting light.

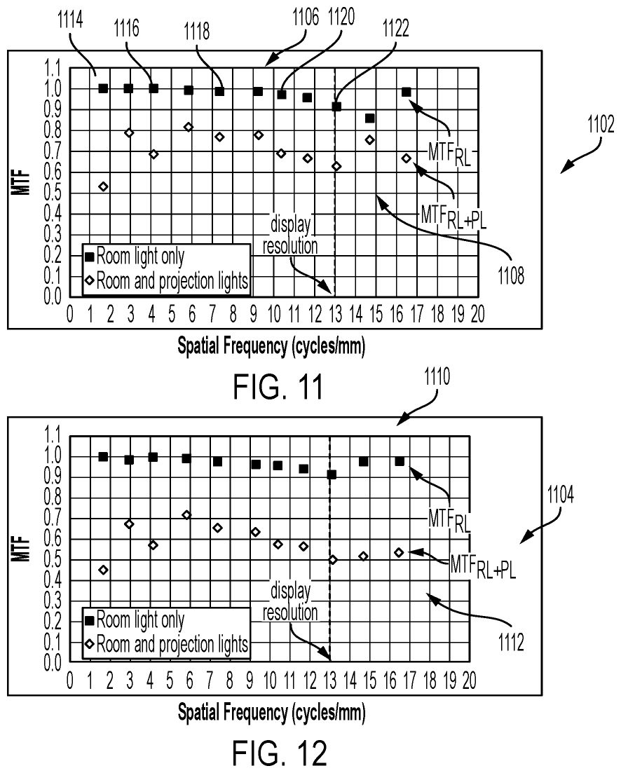

FIGS. 11 and 12 are plots 1102 and 1104 of the MTF values obtained from the images depicted in FIGS. 9A-9F. FIG. 11 includes a first series 1106 representing various MTF values obtained from the image 1004 depicted in FIG. 10B (for the first condition where only the first light sources 808 were on). FIG. 11 also includes a second series 1108 representing various MTF values obtained from the image 1006 depicted in FIG. 10C (for the first condition where both the first light sources 808 and the projection light source 810 were activated). FIG. 12 includes a first series 1110 representing various MTF values obtained from the image 1010 depicted in FIG. 10E (for the second condition where only the first light sources 808 were on).

FIG. 12 also includes a second series 1112 representing various MTF values obtained from the image 1012 depicted in FIG. 10F (for the second condition where both the first light sources 808 and the projection light source 810 were activated). These experimental results indicate that: (1) the very small degradation caused by the room light condition can be resolved by this setup, indicating the sensitivity of the measurement setup is high; (2) the sample 802 only produced the degradation of image contrast, but doesn't affect the resolution of the display; (3) the setup can distinguish the impacts of different group effects on display performance; and (4) the setup can characterize “washout effect” at different angles.

To quantitatively evaluate the impact of the sample 802, the MTF values at the spatial frequencies associated with the points 1114, 1116, 1118, 1120, and 1120 in the first series 1106 were averaged (MTF values at spatial frequencies of 1.67 cycles/mm, 4.11 cycles/mm, 7.33 cycles/mm, 10.38 cycles/mm, and 13.08 cycles/mm were averaged for each of the series 1106, 1108, 1110, and 1112). The “washout” metric described herein was an average of the MTF values over these spatial frequencies for each condition.

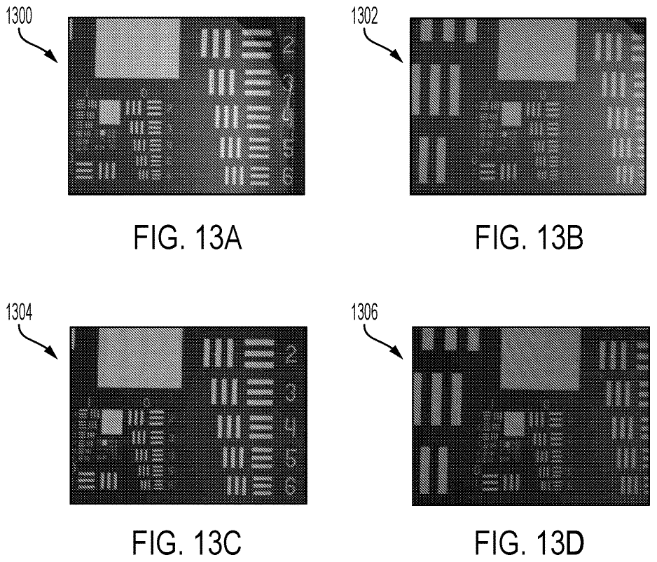

A similar set of measurements as those described herein with respect to FIGS. 10A-12 were taken on a samples (Examples 22 and 5) having a scattering region designed based on a target radial PSD in accordance with Equation 7. Particularly, another set of tests was conducted using two different samples: a first (Example 22) constructed based on a target radial PSD with α=4, θₚₑₐₖ=0.3°, and θₘₐₓ=4° and a second (Example 5, see the Table 1) constructed based on a target radial PSD with α=4, θₚₑₐₖ=0.5°, and θₘₐₓ=4°. Etch depths were 150 nm for these examples. The second sample was subjected to feature rounding via performance of the block 706 of the method 700 depicted in FIG. 7. Each of the samples was tested in each the conditions discussed above were tested (where θᵢ₁=200 and θᵥ₁=0°; and where θᵢ₂=45° and θᵥ₂=20°). FIG. 13A depicts an image 1300 with the projection light source 810 illuminating the first sample in the first condition. FIG. 13B depicts an image 1302 with the projection light source 810 illuminating the first sample in the second condition. FIG. 13C depicts an image 1304 with the projection light source 810 illuminating the second sample in the first condition. FIG. 13D depicts an image 1306 with the projection light source 810 illuminating the second sample in the second condition. The results for the conventional AG Counter Example (depicted in FIGS. 10A-12) and the first and second samples are summarized in the Table 3 below.

TABLE 3

| | Etch | | | Sparkle | Sparkle | Coupled | Coupled | | |
|---|---|---|---|---|---|---|---|---|---|
| | Depth | T | Haze | @200 | @140 | DOI | Rspec | | |
| Sample | (μm) | (%) | (%) | PPI | PPI | (%) | (Rs) | Washout₁ | Washout₂ |
| Counter | — | 93.2 | 6.02 | 1.31 | 1.62 | 94.8 | 15.3 | 0.66 | 0.53 |
| Example 1 | | | | | | | | | |
| Example 22 | 0.15 | 93.2 | 2.92 | 2.41 | 2.71 | 52.31 | 8.54 | 0.58 | 0.44 |
| Example 5 | 0.14 | 93.4 | 1.05 | 1.92 | 2.22 | 78.81 | 14.63 | 0.80 | 0.73 |

As shown in the Table 3, while Example 22 (which did not include feature rounding) provided the best results in terms of specular reflectance reduction (with the coupled specular reflectance (Rs) value being less than 9) and coupled DOI (with the coupled DOI being less than 55%), Example 5 provided vastly superior washout performance, with the washout metric under the first condition being greater than or equal to 0.80 and the washout metric under the second condition being greater than 0.70. Such washout performance was achieved while still providing improved haze, coupled DOI, and R-spec performance as compared to Counter Example 1. These examples demonstrate the capabilities of the articles described herein in achieving unique combinations of performance attributes: transmission haze of less than 2.0% (or even less than 1.5% or less than 1.25%), coupled Rs of less than 15, sparkle (as measured at 140 ppi) of less than 2.5%, a washout metric under the first condition of greater than or equal to 0.7, and a washout metric under the second condition of greater than 0.55. Articles constructed via the methods described herein with feature rounding are particularly well suited for automotive applications, as such a combination of performance attributes indicates consistent display performance over a wide variety of ambient lighting conditions.

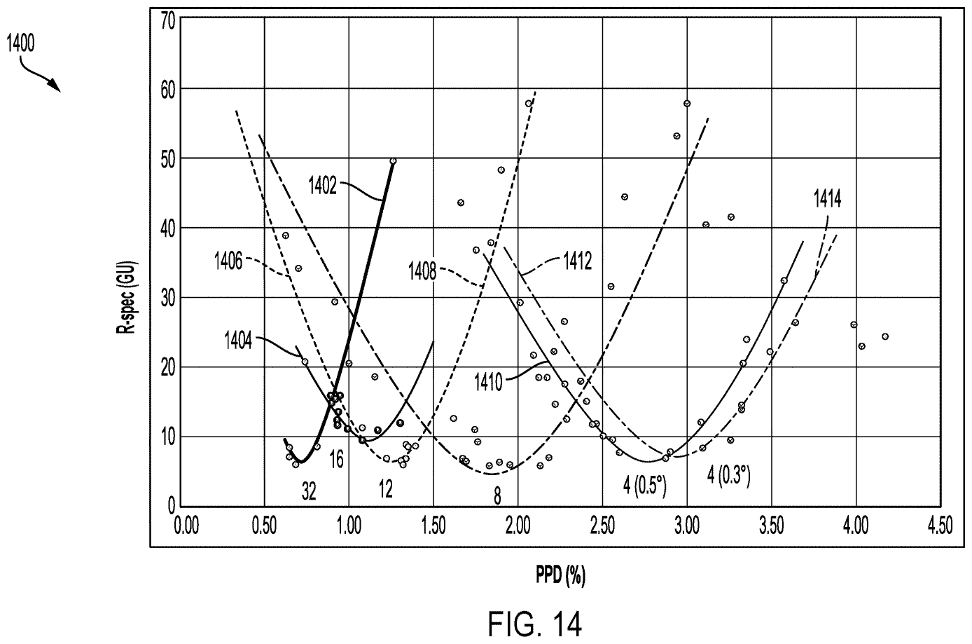

FIG. 14 depicts a plot 1400 of sparkle and specular reflectance (Rs) measurements for the first set of examples (including samples provided in the Table 1 and others). The Rs and sparkle results were plotted in relation to one another to form the plot 1400. Results were fitted to a different curve for each subset of examples formed with a target radial PSD having the same θₘₐₓ value (but with varying a values). A curve 1402 was fit for the results formed using a target radial PSD having θₘₐₓ=32°. A curve 1404 was fit for the results formed using a target radial PSD having θₘₐₓ=16°. A curve 1406 was fit for the results formed using a target radial PSD having θₘₐₓ=12°. A curve 1408 was fit for the results formed using a target radial PSD having θₘₐₓ=8°. A curve 1410 was fit for the results formed using a target radial PSD having θₘₐₓ=4°, and θₚₑₐₖ=0.5°. A curve 1412 was fit for the results formed using a target radial PSD having θₘₐₓ=4°, and θₚₑₐₖ=0.3°. As shown, the examples formed using a target radial PSD having θₘₐₓ=320 provided the most favorable combination of results in terms of spark and Rs, with multiple samples providing sparkle of less than 1% and Rs less than 10.

Of note in the plot 1400 is that each of the curves 1402, 1404, 1406, 1408, 1410, and 1412 suggests a similar minimum Rs value for each subset of examples, in a range of from about 5 to about 9. Each example in the first set of examples represented in the plot 1400 was formed as a binary surface (such that the first major surface 18 within the scattering region 20 contained the plurality of first regions 28 and the plurality of second regions 30, with the plurality of first regions 38 filling approximately 50% of the surface area within the scattering region 20 and the plurality of second regions 30 filling the other 50%). Without wishing to be bound by theory, it is believed that, in the case of an incident plane wave (as depicted in FIG. 3), the specular reflection from a binary image (associated with the height profile H(x,y) within the scattering region 20) depends only on the fill fraction of the binary image and not the image itself. Given this, it is not surprising that each of the curves 1402, 1404, 1406, 1408, 1410, and 1412 suggests a similar Rs floor. Variations in the measured Rs values may be explained by variations from the light source used to measure specular reflectance from a uniform plane wave.

While the above examples described with respect to FIG. 14 were binary surfaces with approximate 50% fill fractions associated with each surface height, it is believed that the fill fractions may be varied and still provide acceptable specular reflectance results. When binary surfaces are used, it is believed that the surface area fraction assumed by each height may be greater than or equal to 40% and less than or equal to 60% (e.g., greater than or equal to 42.5% and less than or equal to 57.5%, greater than or equal to 45% and less than or equal to 55%, greater than or equal to 47.5% and less than or equal to 52.5%) while still providing acceptable specular reflectance reduction (as compared to an untextured version of the substrate 12 without the scattering region). To illustrate, with reference to FIG. 2, one of the plurality of first regions 28 and the plurality of second regions 30 may have a combined surface area that constitutes greater than 50% of the total surface of the scattering region 20 (e.g., greater than 50% and less than or equal to 60%), while the other one of the plurality of first regions 28 and the plurality of second regions 30 may have a combined surface area that constitutes less than 50% of the total surface area of the scattering region 20 (e.g., less than 50% and greater than or equal to 40%), while still providing acceptable specular reflectance performance.

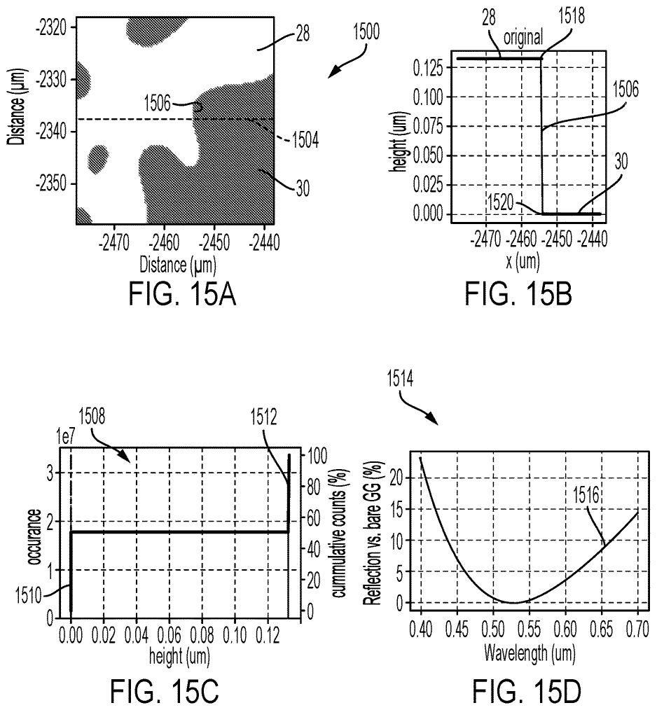

Additional modelling was performed to examine the effects of feature rounding on optical performance. FIG. 15A depicts a portion of a surface 1500 that is modelled. The surface was generated using a target radial PSD with θₘₐₓ=4°, θₚₑₐₖ=0.5°, α=4. shown in FIG. 15A, the surface 1500 includes a first region 28 disposed at a first height and a second region 30 disposed at a second height, where the first height differs from the second height by about 130 nm. A transition surface 1506 is a surface where the surface 1500 transitions between the first height and the second region. In this example, it was assumed that, within the transition surface 1506, the surface 1500 extended perpendicular to the direction in which the surface extends in the first region 28 and the second region 30. FIG. 15B depicts a cross-sectional view of the surface 1500 through the line 1504 depicted in FIG. 15A. As shown, the line 1504 extends parallel to a surface normal of the transition surface 1506. The transition surface 1506 is depicted to have an undefined slope. FIG. 15C depicts a plot 1504 of the occurrences of surface height measurements across the surface 1500. As shown, a first grouping of height occurrences 1510 at the second height accounts for 50% of the measured height occurrences and a second group of height occurrences 1512 at the first height accounts for the other 50% of measured height occurrences. This indicates that there are no heights measured between the first height and the second height, which is consistent with the undefined slope of the transition surface 1506. FIG. 15D depicts a plot 1514 of an estimated specular reflectance reduction as a function of wavelength. As shown, the minimum specular reflectance for this design occurs at about 525 nm.

To estimate the effects of feature rounding, the surface 1500 was modified where the slope transitioned from the first and second regions 28 and 30 to the transition surface 1506.

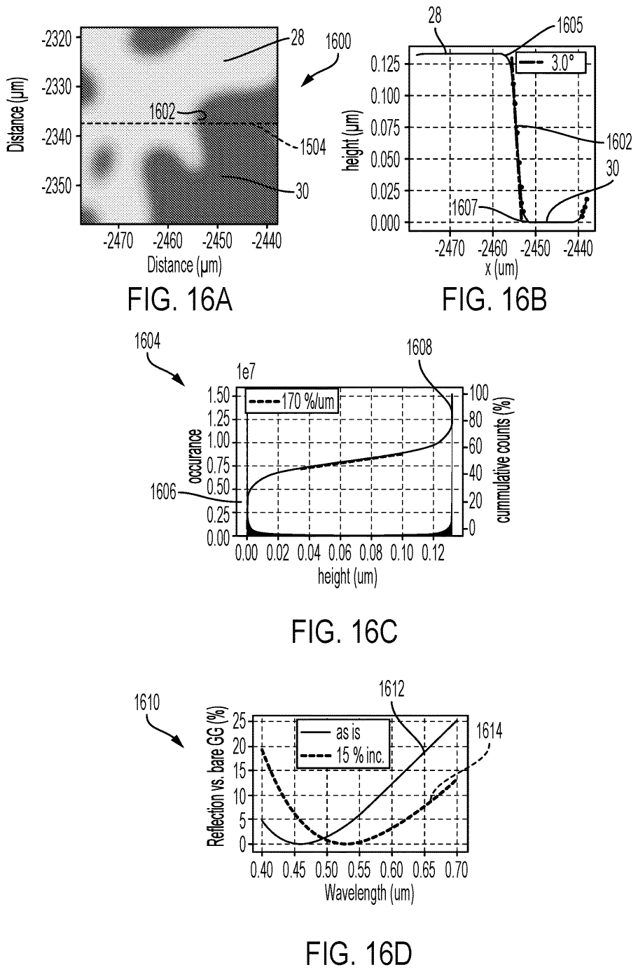

Particularly, the corners 1518 and 1520 (see FIG. 15B) were rounded via application of a Gaussian Blur Filter (the imgaussfilt image filter in Matlab™ was used to define the amount of feature rounding). FIG. 16B depicts a portion of the modified surface 1600. As a result of the feature rounding, the modified surface 1600 includes a transition surface 1602 between the region 28 and the region 30 that has a finite slope (in this example, the slope was such that the transition surface 1602 extended in a plane extending at 3° relative to the direction of the first region 28). FIG. 16B depicts a cross-sectional view of the modified surface 1600 through the line 1504 depicted in FIG. 16A. As shown, at the corners 1605 and 1607, the slope of the modified surface 1600 more gradually transitions between the values at the regions 28 and 30 and value within the transition surface 1602 than at the corners 1518 and 1520 depicted in FIG. 15B. That is, in the modified surface 1600, the slope has smoother transitions than in the surface 1500. FIG. 16C depicts a plot 1604 of the occurrences of surface height measurements across the modified surface 1600. As shown, a first grouping of height occurrences 1606 at the second height accounts for about 30% of the measured height occurrences and a second group of height occurrences 1608 at the first height accounts for about 30% of measured height occurrences. This indicates that about 40% of the height occurrences are at heights other than the first and second heights, which is consistent with the finite slope of the transition surface 1602. In this case, it was determined that the lateral distance (along the line 1504, see FIG. 16A) between the first region 28 and the second region 30 was about 2.3 μm (corresponding to the width w depicted in FIG. 3B). Moreover, the probability count curve had a slope of 170%/μm. FIG. 16D is a plot 1610 including curves 1612 and 1614 of modelled specular reflectance of the modified surface 1600. The curve 1612 represents modelled specular reflectance when the modified surface 1600 had the same etch depth as the example depicted in FIG. 15B, whereas the curve 1614 represents the modelled specular reflectance when the modified surface 1600 etch depth was increased 15% to bring the minimum to approximately 525 nm. As shown, the smoother transitions associated with the modified surface 1600 are not anticipated to reduce the minimum specular reflection, but rather shift the wavelength at which specular reflectance is the lowest. It is believed that this wavelength shift can be compensated by adjusting the etch depth.

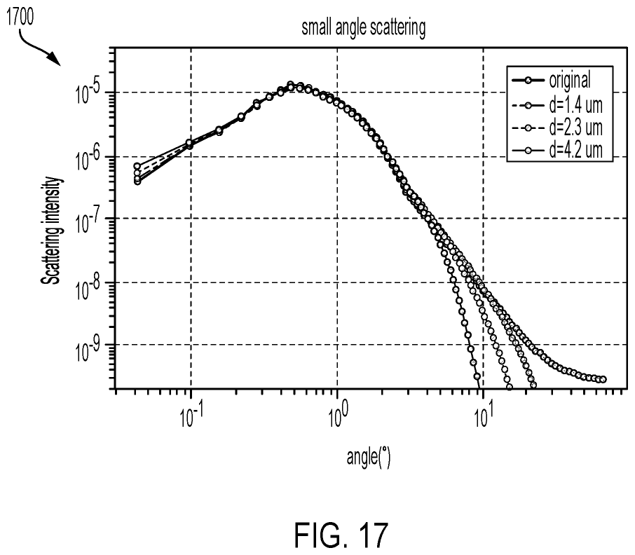

FIG. 17 depicts a plot 1700 of modelled radial PSDs for four surfaces with varying degrees if feature rounding. As shown, the value d in the legend indicates the lateral distance (measured in a direction perpendicular to respective transition surface) between edges of the first region 28 and the second region 30 (corresponding to the width w depicted in FIG. 3B). As shown, the radial PSDs are reduced for the examples with larger values ford. Samples with greater amounts of feature rounding (such that the slope of the first major surface 18 transitions from a minimum value to a maximum value over a greater lateral distance) are predicted to have lower PSDs at relatively large scattering angles of greater than or equal to 7°. It is believed that these lower PSDs for samples with greater amounts of feature rounding provide superior washout performance over unrounded samples by providing lower scattering amplitudes at high scattering angles.

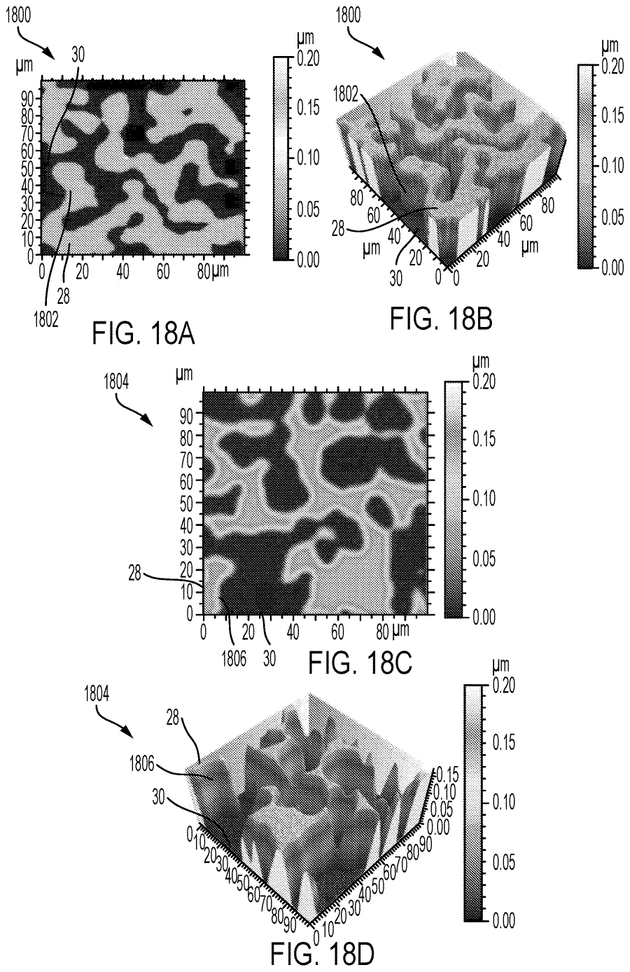

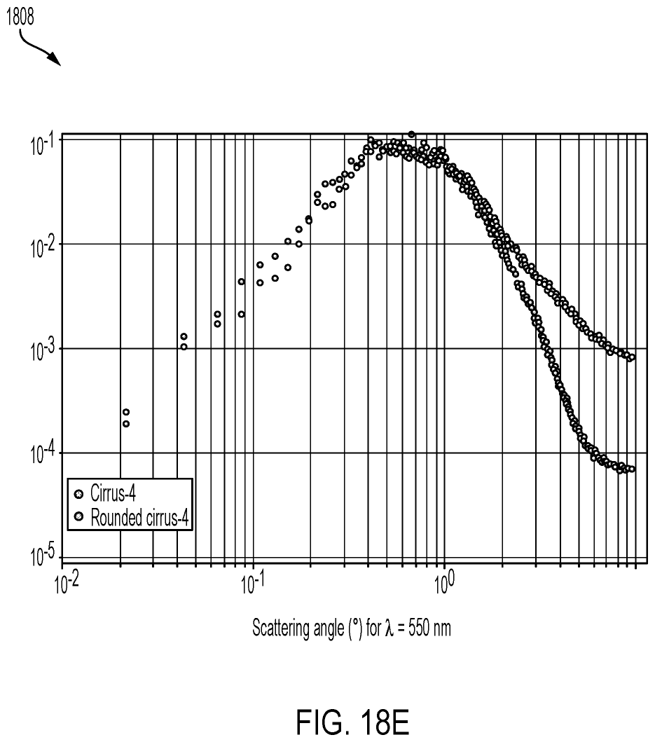

Radial PSDs were measured from two different samples to confirm the results of the modelling described with respect to FIGS. 16A-17. The samples were generated using a target radial PSD with θₘₐₓ=4, α=4 and θₚₑₐₖ=0.5. FIGS. 18A and 18B are images showing plan and perspective views, respectively, of a surface 1800 formed without feature rounding (the adhesion between the resist and substrate was not controlled). The images were generated from white light interferometer measurements of the surface 1800. As shown, the surface 1800 included a first region 28 disposed at a first height, a second region 30 disposed at a second height, and a transition surface 1802 extending between the first region 28 and the second region 30. FIGS. 18C and 18D are images showing plan and perspective views, respectively, of a surface 1804 formed with feature rounding (adhesion between the resist and substrate was controlled). The images were generated from white light interferometer measurements of the surface 1802. As shown, the surface 1800 included a first region 28 disposed at a first height, a second region 30 disposed at a second height, and a transition surface 1806 extending between the first region 28 and the second region 30. As a result of the feature rounding, the transition surface 1806 has a lesser slope than the transition surface 1802 shown in FIGS. 18A-18B. The width w (see FIG. 3B) over which the height of the surface 1804 transitioned from the first height to the second height was measured to be between 2.0 μm and 10.0 μm.

FIG. 18E is a plot 1808 of radial PSDs 1810 and 1812 measured from the surfaces 1800 and 1804 depicted in FIGS. 18A-18D, respectively. The radial PSDs 1810 and 1812 were plotted from the white light interferometry data depicted in FIGS. 18A-18D in Gwyddion. The radial PSDs 1810 and 1812 were generated from white light interferometry data (with a lateral resolution of about 360 nm) from a 1×1 mm area of each surface. The radial PSDs 1810 and 1812 were generated from a full 1×1 mm areas, but the images in FIGS. 18A-18D represent subsections of the imaged areas. It has been found that the particular 1×1 mm area used does not affect the resultant radial PSD. As shown, the radial PSD 1810 associated with the surface 1800 is significantly higher than the radial PSD 1812 associated with the surface 1804 at scattering angles greater than 5°. Indeed, the radial PSD 1812 decreases to a value that is 0.1% of the peak value at a scattering angle that is less than or equal to 8° relative to the specular direction. The radial PSD 1812 decreases to a value that is 0.01% of the peak value at a third scattering angle that is less than or equal to 16° relative to the specular direction. The radial PSD 1810, in contrast, is greater than 10⁻³ times its peak value at a scattering angle of 10°. Such a lower measured radial PSD provided by feature rounding demonstrates the efficacy of feature rounding performed via the methods described herein.

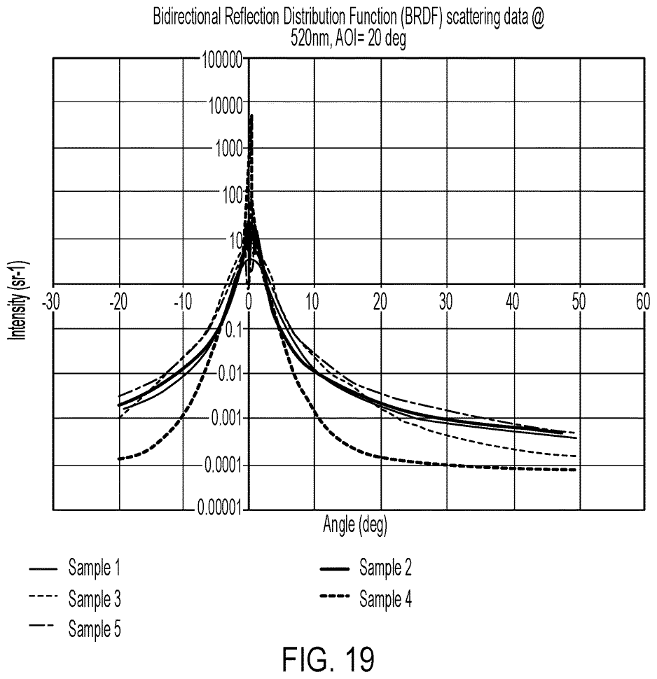

Bidirectional Reflection Distribution Function (BRDF) measurements were taken for five different samples fabricated in accordance with the methods described herein. A first sample did not have feature rounding and was formed based on a target radial PSD with θₘₐₓ=4°, α=4, and θₚₑₐₖ=0.3°. A second sample did not have feature rounding and was formed based on a target radial PSD with θₘₐₓ=4°, α=4, and θₚₑₐₖ=0.5°. A third sample did have feature rounding and was formed based on a target radial PSD with θₘₐₓ=8°, α=5, and θₚₑₐₖ=0.3°. A fourth sample did have feature rounding and was formed based on a target radial PSD with θₘₐₓ=8°, α=5, and θₚₑₐₖ=0.3°. A fifth sample did not have feature rounding and was formed based on a target radial PSD with θₘₐₓ=8°, α=4, and θₚₑₐₖ=0.3°. Measurements were taken in reflection mode using the REFLET 180S system from Synopsys, Inc. FIG. 19 depicts a plot 1900 of the results measured with 520 nm at an angle of incidence of 20°. As shown, the samples with feature rounding exhibited lower scattering intensities at scattering angles greater than 20° relative to specular. When normalized relative to specular peaks, the efficacy of feature rounding at reducing scattering amplitudes at relatively high scattering angles is even more pronounced. At a scattering angle of 20° relative to specular, the third and fourth samples (those with feature rounding) exhibited scattering intensities less than 10⁻⁶ times the intensity measured at their specular peaks (with Sample 4 exhibiting a value less than 10⁻⁷ times the intensity at its specular peak). The samples without feature rounding, in contrast, all exhibited BRDF amplitudes greater than 10⁻⁵ times their specular peaks at a scattering angle of 20°. In terms of actual (non-normalized) BRDF amplitudes, the samples with feature rounding each exhibited BRDF amplitudes of less than 1.7e-4 sr⁻¹ at a 30° scattering angle, or BRDF amplitudes of less than 1.5e-4 sr⁻¹ at a 40° scattering angle. Such relatively low BRDF amplitudes at high scattering angles achieved by the samples with feature rounding demonstrates the superior washout performance of such samples.

An additional set of samples was fabricated using multiple etches. Parameters associated with each step, including target radial PSD for each etch and etch depth, as well as results of optical performance measurements are provided in the Table 4 below.

TABLE 4

| | | | | Etch 1 | | | | Etch 2 | | | c- | | | |
|---|---|---|---|---|---|---|---|---|---|---|---|---|---|---|
| | Etch | Etch 1 | Etch 1 | depth | Etch | Etch 2 | Etch 2 | depth | Haze | PPD | DOI | | | |
| Example | 1 α | Θₚₑₐₖ | Θₘₐₓ | (nm) | 2 α | Θₚₑₐₖ | Θₘₐₓ | (nm) | (%) | (%) | (%) | Rs | Washout₁ | Washout₂ |
| 23 | 4 | 0.5 | 4 | 123 | 4 | 0.5 | 4 | 154 | 5.35 | 3.39 | 25 | 3.76 | 0.41 | 0.3 |
| 24 | 5 | 0.3 | 16 | 126 | 5 | 0.3 | 16 | 330 | 39 | 2.43 | 52.8 | 2.64 | — | — |
| 25 | 5 | 0.3 | 16 | 128 | 5 | 0.3 | 16 | 177 | 19 | 1.6 | 63.4 | 1.57 | — | — |
| 26 | 5 | 0.3 | 16 | 130 | 5 | 0.3 | 16 | 176 | 20.1 | 1.53 | 55.8 | 1.53 | — | — |

Additional measurements were taken on samples with multiple etch steps and the set of performance attributes expected to be achieved with various etching sequences is summarized in the Table 5 below.

TABLE 5

| | | | Etch 1 | | | | Etch 2 | | | c- | | | |
|---|---|---|---|---|---|---|---|---|---|---|---|---|---|
| Etch | Etch 1 | Etch 1 | depth | Etch | Etch 2 | Etch 2 | depth | Haze | PPD | DOI | | | |
| 1 α | Θₚₑₐₖ | Θₘₐₓ | (nm) | 2 α | Θₚₑₐₖ | Θₘₐₓ | (nm) | (%) | (%) | (%) | Rs | Washout₁ | Washout₂ |
| 4 | 0.5 | 4 | 119-134 | 4 | 0.5 | 4 | 102-220 | 3.6-8.7 | 2.8-4.0 | 25-72 | 3.8-15.6 | 0.41-0.45 | 0.3-0.34 |
| 5 | 0.3 | 16 | 111-129 | 5 | 0.3 | 16 | 259-330 | 30.5-39.0 | 2.2.0-2.5 | 53-96 | 2.6-13.8 | — | — |
| 5 | 0.3 | 16 | 121-130 | 5 | 0.3 | 16 | 169-269 | 16.2-29.4 | 1.1.5-2.0 | 63.91 | 1.6-7.0 | — | — |
| 5 | 0.3 | 16 | 121-130 | 5 | 0.3 | 16 | 69-230 | 9.6-39.7 | 1.1-2.4 | 56-91 | 1.2-8.4 | — | — |

As demonstrated by a comparison between the Tables 1 and 2 and the Tables 4 and 5, samples fabricated with multiple etch steps tend to have increased sparkle and haze relative to those fabricated using a single etch step. However, specular reflection and coupled distinctness of image can be significantly reduced in the multiple etch designs. The presence of multiple levels enables the interferometric suppression of the specular reflection over a broad optical bandwidth. As shown in the Table 4, Rs values obtained with the multi-etch designs were generally less than 4.0, and in some cases less than 3.0 or even less than 2.0. The single etch designs, in contrast, had much higher Rs values. Coupled distinctness of image values achieved by the multi-etch designs were generally less than 65%, and in some cases less than 55%, and in one example even less than 30%. Generally, the design used will be dictated by performance attributes desired for a particular application. Single etch designs may be desired in applications where low haze, sparkle, and superior washout performance (such as in automotive interior displays) is desired, whereas applications demanding superior specular reflectance reduction and/or DOI may be suitable for a multi-etch design.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, “a” is intended to comprise one or more than one component or element and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

1. An article comprising:
a substrate comprising:
a first major surface;
a second major surface opposing the first major surface; and
a scattering region formed in the first major surface, wherein, within the scattering region, the first major surface comprises:
a plurality of first regions disposed at a first height relative to an imaginary base plane extending through the substrate, and
a plurality of second regions disposed at a second height relative to the imaginary base plane, wherein:
the first height is greater than the second height by an etch depth that is greater than or equal to 80 nm and less than or equal to 600 nm,
the scattering region comprises a radial PSD that comprises:
a first range of scattering angles in which the radial PSD increases with an increase in a scattering angle of light relative to a specular direction,
a peak angle θₚₑₐₖ where the radial PSD comprises a peak value, and
a second range of scattering angles at angles greater than θₚₑₐₖ in which the radial PSD decreases to 10% of the peak value at a first scattering angle that is greater than or equal to 2° and less than or equal to 15° relative to the specular direction.

2. The article according to claim 1, wherein, within the second range of scattering angles, the radial PSD decreases to 1% of the peak value at a second scattering angle that is greater than the first scattering angle and greater than or equal to 3.5° and less than or equal to 30° relative to the specular direction.

3. The article according to claim 2, wherein, within the first range of scattering angles, the radial PSD is less than 10% of the peak value at scattering angles greater than or equal to 0.05°.

4. The article according 2, wherein:
the first scattering angle is greater than or equal to 6° and less than or equal to 13° relative to the specular direction, and
the second scattering angle is greater than or equal to 12.5° and less than or equal to 30.0° relative to the specular direction.

5. The article according to claim 2, wherein:
the first scattering angle is greater than or equal to 2° and less than or equal to 7° relative to the specular direction, and
the second scattering angle is greater than or equal to 3.5° and less than or equal to 13.5° relative to the specular direction.

6. (canceled)

7. The article according to claim 5, wherein, within the second range of scattering angles, the radial PSD decreases to a value that is 0.01% of the peak value at a third scattering angle that is less than or equal to 16° relative to the specular direction.

8. The article according to claim 1, wherein θₚₑₐₖ is greater than or equal to 0.3 and less than or equal to 0.5°.

9. The article according to claim 1, wherein:
within the scattering region, the first major surface comprises a plurality of sloped transition surfaces extending between boundaries of the plurality of first regions and the plurality of second regions, and
the plurality of sloped transition surfaces are sloped such that a height of the first major surface decreases with increasing distance from boundaries of the plurality of first regions.

10. The article according to claim 9, wherein at least some of the plurality of sloped transition surfaces extend a lateral distance that is greater than or equal to 1.0 μm and less than or equal to 10 μm between ones of the plurality of first regions and the plurality of second regions that are connected by the sloped transition surfaces, wherein the lateral distance extended by a sloped transition surface is measured in a direction parallel to a surface normal of the sloped transition surface and parallel to the imaginary base plane.

11. The article according to claim 1, wherein the article exhibits:
a transmission haze of less than or equal to 2.0%, and
a sparkle of less than or equal to 2.5% when measured at 140 ppi.

12. The article according to claim 1, wherein a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.55 when the article is viewed at a 0° viewing angle and light having a luminance of 45000 lux is incident on the first major surface at an angle of incidence of 20°.

13. (canceled)

14. The article according to claim 1, wherein a second average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.6 when the article is viewed at a 20° viewing angle and light having a luminance of 45000 lux is incident on the first major surface at an angle of incidence of 45°.

15. The article according to claim 1, wherein:
within the scattering region, the first major surface comprises:
a plurality of third regions disposed at a third height relative to the imaginary base plane, and
a plurality of fourth regions disposed at a fourth height relative to the imaginary base plane, and
the fourth height is different from the first height, the second height, and the third height.

16. The article according to claim 15, wherein the article exhibits:
a specular reflectance (Rs) of less than or equal to 4.0, and
a coupled distinctness of image of less than 65%.

17. (canceled)

18. An article comprising:
a first major surface;
a second major surface opposing the first major surface; and
a scattering region formed in the first major surface, wherein, within the scattering region, the first major surface comprises:
a plurality of first regions disposed at a first height relative to an imaginary base plane extending through the substrate, and
a plurality of second regions disposed at a second height relative to the imaginary base plane, wherein:
the first height is greater than the second height by an etch depth that is greater than or equal to 80 nm and less than or equal to 600 nm,
the scattering region comprises a radial PSD that comprises a first range of scattering angles on one side of a peak angle (θₚₑₐₖ) where the radial PSD increases with increasing scattering angle and a second range of scattering angles on a second side of θₚₑₐₖ where the radial PSD decreases with increasing scattering angle,
a bidirectional reflectance distribution function (“BRDF”) of the article is less than 10⁻⁵ times a peak intensity value at a scattering angle of 20° relative to specular, and
the BRDF is measured from light having a wavelength of 520 nm that is incident on the first major surface at an angle of incidence of 20°.

19. The article according to claim 18, wherein the BRDF comprises an amplitude of less than 1.7×10⁻⁴ sr⁻¹ at a 30° scattering angle relative to specular.

20. The article according to claim 18, wherein, within the second range of scattering angles, the radial PSD decreases to 10% of a peak value at θₚₑₐₖ at a first scattering angle that is greater than or equal to 2° and less than or equal to 15° relative to the specular direction.

21. The article according to claim 20, wherein, within the second range of scattering angles, the radial PSD decreases to a value that is 1% of the peak value at a second scattering angle that is greater than the first scattering angle and greater than or equal to 3.5° and less than or equal to 30° relative to the specular direction.

22. (canceled)

23. (canceled)

24. (canceled)

25. (canceled)

26. (canceled)

27. (canceled)

28. The article according to claim 18, wherein the article exhibits:
a transmission haze of less than or equal to 2.0%, and
a sparkle of less than or equal to 2.5% when measured at 140 ppi.

29. An article comprising:
a substrate comprising:
a first major surface;
a second major surface opposing the first major surface; and
a scattering region formed in the first major surface, wherein, within the scattering region, the first major surface comprises:
a plurality of first regions disposed at a first height relative to an imaginary base plane extending through the substrate,
a plurality of second regions disposed at a second height relative to the imaginary base plane, and
a plurality of sloped transition surfaces extending between boundaries of the plurality of first regions and the plurality of second regions, wherein:
the plurality of sloped transition surfaces are sloped such that a height of the first major surface decreases with increasing distance from boundaries of the plurality of first regions,
at least some of the plurality of sloped transition surfaces extend a lateral distance that is greater than or equal to 1.0 μm and less than or equal to 10 μm between ones of the plurality of first regions and the plurality of second regions that are connected by the sloped transition surfaces, wherein the lateral distance extended by a sloped transition surface is measured in a direction parallel to a surface normal of the sloped transition surface and parallel to the imaginary base plane, and
the scattering region comprises a radial PSD that comprises:
a first range of scattering angles where the radial PSD increases with an increase in a scattering angle of light relative to a specular direction,
a peak scattering angle θₚₑₐₖ where the radial PSD comprises a peak value, and
a second range of scattering angles at scattering angles greater than θₚₑₐₖ where the radial PSD decreases to 10% of the peak value at a first scattering angle that is greater than or equal to 2° and less than or equal to 15° relative to the specular direction.

30. (canceled)

31. (canceled)

32. (canceled)

33. (canceled)

34. (canceled)

35. (canceled)

36. (canceled)

37. (canceled)

38. (canceled)

39. (canceled)
